(19) United States
(12) Patent Application Publication
(10) Pub. No.: US 2022/0397686 A1
(43) Pub. Date: Dec. 15, 2022

(54) Platforms, Systems, and Methods for Community Video Security Services that provide Elective and Resource Efficient Privacy Protection

(71) Applicant: CORETECH LABS, LLC, Corona Del Mar, CA (US)

(72) Inventors: Walter Scacchi, Corona Del Mar, CA (US); Jack Zeineh, Newport Coast, CA (US); Rui-Tao Dong, Newport Beach, CA (US)

(21) Appl. No.: 17/837,673

(22) Filed: Jun. 10, 2022

Related U.S. Application Data
(60) Provisional application No. 63/209,912, filed on Jun. 11, 2021.

(51) Int. Cl. G01S 19/48; H04W 4/029; G06F 21/62

(52) U.S. Cl. CPC G01S 19/485; H04W 4/029; G06F 21/6245

(57) ABSTRACT

In general, platforms, systems, and methods are provided for identifying and privacy protecting authorized persons, vehicles, and objects in motion in the field of view of a video security camera or set of networked security cameras for use in a residential or business community. Various embodiments incorporate a security identification system that includes one or more mobile devices such as a smartphone or smartwatch, one or more cameras situated within a community with processors connected to data centers via the internet, and software running a cloud service infrastructure communicating to both the smartphone or smartwatch. The system can also include the ability to translate locational information from a smartphone or smartwatch into corresponding identification and geolocation information on images from security cameras.

### CROSS REFERENCE TO RELATED APPLICATIONS

The present application claims priority to U.S. Provisional Patent Application No. 63/209,912 entitled “Platforms, Systems, and Methods for Community Video Security Services that provide Elective and Resource Efficient Privacy Protection” filed Jun. 11, 2021, which is hereby incorporated by reference in its entirety.

### TECHNICAL FIELD

The subject matter described herein relates to platforms, systems and methods for providing video surveillance capabilities for residential and business communities that are able combine the capabilities of multiple surveillance system devices, systems, and platforms providing privacy protection capabilities for community members through resource efficient ways and means.

BACKGROUND

People are becoming increasingly aware of ways and means by which data about their actions or behavior is capable of being monitored, captured, and analyzed at a distance. People value their privacy whether to be able to operate with a sense of personal solitude, anonymity, or with informational self-determination whereby they want to be aware of what data is potentially collected about them, along with their desire to decide when and where such data can be collected, stored, or shared with others. People are very concerned about their privacy when in the presence of video surveillance systems, and they want means to protect their privacy from intrusion, while realizing the potential security benefits afforded by such systems.

Some video surveillance cameras are connected to multi-camera system networks (hereafter, video surveillance systems or VSS) to capture and to record video as a normal mode of operation. These are commonly embodied using closed-circuit television (CCTV) camera devices and systems that are positioned around areas, properties, roadways, entry/exit doorways, or facilities of interest. In most situations, these VSS record video surveillance streams that document and produce visual records of what the cameras observed during their operation. If such video recordings have value, it is usually as an evidentiary record after some security event or criminal transgression has occurred within the potential field of view (FOV) of one or more security cameras. The recorded video might then be reported, transmitted, and viewed by security personnel, police, or public safety personnel to see if the security cameras captured and recorded the event or transgression of interest. In turn, those authorized to review the video records attempt to recognize and identify the perpetrators if there was a criminal activity or security event transgression. Because of such capabilities, VSS are said to also act as passive deterrents to crime or security violations. These are often the recited benefits of VSS.

In some situations, VSS video streams are visually monitored on video screens by security personnel to detect possible security intrusion events, such as someone entering a closed facility being monitored for entry of unauthorized personnel. Human monitoring of these video surveillance streams is tedious, and prone to oversights if security personnel are not continuously attentive, alert, and aware of potential security threats. Worse yet, sometimes unscrupulous security personnel or unknown third-parties abuse the VSS they monitor to invade the privacy of persons that have been recorded, by unauthorized access and sharing of such video recordings without prior permission from those observed. Subsequently, sometimes VSS are used as privacy invasion systems. Such abuse is unacceptable in an open, free society.

### SUMMARY

Aspects of the current subject matter relate inter alia to platforms, systems, and methods for computationally combining and integrating multiple video surveillance security devices and systems from one or more independent security services providers into a single continuous security services capability that operates as a community-based video security system, and that provides capabilities to electively determine privacy protection of authorized persons, vehicles, and other objects that can move freely and safely within their community, while doing so in a resource efficient manner.

In one aspect, a system or method is provided for determining the location and identifying authorized humans, vehicles, and other registered objects in motion bearing a mobile signaling device within a fixed camera's field of view. In one embodiment, the system or method includes a video camera with known GPS coordinates observing a Field of View (FOV), a computer processor attached to the camera, a computing server in communication with the camera processor through data network means, a mobile device with means to determine and wirelessly transmit its GPS location coordinates through a data network, software functionality operating within camera processor capable of detecting visual features in motion within the camera FOV, computational and networked means for requesting from the mobile device its GPS location coordinates, and computational means for determining if the authorized humans, vehicles, or other registered objects bearing such a mobile device that transmits its GPS location coordinates, is observed within the FOV of the camera. The system or method can have any number of variations.

In another aspect, a system or method is provided for determining GPS location coordinates for pixels appearing and captured in a camera's video recorded image. In one embodiment, the system or method includes a video camera with known GPS coordinate location observing a Field of View (FOV), a computer processor attached to the camera, a computing server in communication with the camera processor, a mobile device with GPS coordinates, software functionality operating within camera processor supporting designation of regions in the camera FOV as geofenced areas or boundaries, software functionality operating within camera processor capable of detection visual features in motion within the camera FOV, enabling means for requesting from the mobile device of its location, capturing of multiple points within the field of view image of the camera that establish (1) imaging pixel coordinates and (2) GPS location coordinates for the pixel coordinates, and calculating means for determining approximate GPS location coordinates for any pixel in the image using computational depth estimation means. The system or method can have any number of variations.

In another aspect, a system or method is provided for determining a visual area that circumscribes and covers an authorized user, vehicle, or object with a location signaling device enabled and privacy protection selected, who is in motion within and across a continuous sequence of cameras images. In one embodiment, the system or method includes a video camera with known geolocation registration observing a calibrated Field of View (FOV), a computer processor attached to the camera, software functionality operating within camera processor supporting designation of regions in the camera FOV as geofenced areas or boundaries, software functionality operating within camera processor capable of detection visual features in motion within the camera FOV, a computing server in communication with the camera processor, a mobile device with GPS coordinates and wireless position signalling means, requesting from the mobile device of its location, capturing and detecting a bounded area visual feature in motion within the camera's field of view, determining if the visual feature in motion is associated with the location of a signalling device that is transmitting or has transmitted the device's geolocation, where this location co-occurs within the camera's FOV, said signalling device is transmitting or has transmitted the mobile device bearer's privacy protection elected value, and such value is set to privacy protection, assigning a visually opaque graphic overlay onto the bounded area visual feature in motion within the camera's FOV, the visually occluded and elected privacy protection video recording is then ready for any further processing, security encryption, and secure transfer over the CVSS data communication network, and terminating the assigned graphic overlay of the bounded area visual feature after the user, vehicle, or other authorized object with mobile signaling means selected for privacy protection is no longer observed within the camera's FOV. The system or method can have any number of variations.

In another aspect, a system or method is provided for storing and transacting Privacy Protection Passports (PPP) and Privacy Protection Visas (PPV). In one embodiment, the system or method includes PPP and PPV denote a computer processable data record that represents user privacy protection credentials stored within a digital record on an authorized user mobile device or networked personal computer, PPP and PPV are represented as computer processable data records stored within a distinct, CVSS data repository, PPP and PPV data storage and transaction repository (e.g., distributed blockchain ledger), computational means for establishing and authorizing CVSS services transactions using PPP or PPV opt-in and opt-out election signals, computational means for generating PPP or PPV election signals capable of being transmitted across CVSS networks from authorized users mobile devices, means for computationally generating such signals in ways that are resistant to tampering and forging (e.g., optionally PPP or PPV taggants), computational means for enacting PPP or PPV elections to cloak CVSS video records that include authorized users, vehicles, or movable objects, and computational means for enacting PPP or PPV elections to block cloaking or to uncloak CVSS video records that include authorized users, vehicles, or movable objects, by RBU residents that access those video records associated with specified cameras associated with residents' RBU such that residents can always access uncloaked video recordings captured by RBU cameras attached to their residence, or that communities have attached to common community regions or facilities, that they have respectively connected to the CVSS. The system or method can have any number of variations.

In another aspect, a system or method is provided for identifying and privacy protecting authorized persons, vehicles, and objects in motion observed in video stream recordings. In one embodiment, the system or method includes a camera or network of connected cameras capable of detecting, recording, visually highlighting or reporting observed elements in motion in video output streams, a calibrated video security camera or set of networked calibrated security cameras, capable of detection visual elements in motion located within a camera's field of view appearing in a video output stream, a computer processor attached to each camera, or each camera network, a computing server in communication with the camera processor, a system capability that is used to authorize and register persons, vehicles, and other objects with persistent identifiers used by the system, a system capability that is used to identify registered persons, vehicles, and other objects carrying or bearing a privacy election passport that can be detected by a calibrated camera system means to be located and observed to be in motion within the field of view of the calibrated camera or camera system, and a mobile device means through which an authorized, registered person, vehicle or other object can automatically signal its geolocation coordinates to the system through networked means via an encrypted privacy election passport data record. The system or method can have any number of variations.

In another aspect, a system or method is provided elective signaling to control video recording, privacy protected video content filtering, and video encryption. In one embodiment, the system or method includes a camera or network of connected cameras capable of detecting, recording, visually highlighting or reporting observed elements in motion in the camera images appearing in a video output streams, a calibrated video security camera or set of networked calibrated security cameras, a computer processor attached to each camera, or each camera network, capable of detection visual elements in motion located within a camera's field of view images appearing in a video output stream, a computing server in communication with the camera processor, a mobile device with signaling means and networked mobile software app that can determine and transmit the device's locational position coordinates to an RBU's camera processor connected to CVSS networks, a mobile device with signaling means and networked mobile software app that can determine and transmit the device's authorized user privacy election passport to an RBU's camera processor connected to CVSS networks, a calibrated video security camera or set of networked calibrated RBU security cameras, capable of detection visual elements in motion located within a camera's field of view appearing in the video output stream that correspond to the locational position of an authorized user mobile device that signals its location and the privacy election passport setting value, and if the privacy passport election value is set to cloak user's privacy using a privacy cloaking encryption key, then the RBU's camera processor, when detecting observable entities in motion, adds a graphic opacity overlay filter into the motion detected region, prior to overall video recording stream encryption and transmission over CVSS data networks. The system or method can have any number of variations.

In another aspect, a system is provided including computer servers and network infrastructure that support system user authorization, security, and firewall services for privacy protected video files and data stored in repositories. In one embodiment, the system consists of one or more computer servers with network connections that operate as a cloud-based services data center, one or more computer servers that provide system user authorization, security, and firewall services within the data center, one or more computer servers that provide access to cloud-based content networking computation resources that enable event notification services, application and administrative services, and storage repository services based on user authorization and delegation assignments, one or more computer servers that provide video stream file storage transaction services to authorized users or their delegates, one or more computer servers that provide meta-data database management services to authorized users or their delegates, and role-based access control capability lists that utilize an itemized set of authorized user roles and identified users as role instances. The system can have any number of variations.

In another aspect, a system is provided including computer servers and network infrastructure that support system authorized users services for elective privacy protection of video files and data stored in repositories. In one embodiment, the system consists of one or more computer servers with network connections that operate as a cloud-based services data center, one or more computer servers that provide system user authorization, security, and firewall services within the data center, one or more computer servers that provide authorized users access to cloud-based content networking computation resources that enable event notification services, application and administrative services, and storage repository services for elective privacy protected video stream files and meta-data that are managed as digital storage archives, and computational means for administering digital storage archives that track and organize video files and meta-data in forms appropriate for long-term storage or removal based on the age of the video materials. The system can have any number of variations.

In another aspect, computer servers and network infrastructure are provided that support system user elected privacy protection of video files and data stored in repositories. In one embodiment, the computer servers and network infrastructure consist of (a) one or more computer servers with network connections that operate as a cloud-based services data center, (b) one or more computer servers that provide system user authorization, security, and firewall services within the data center, (c) one or more computer servers that provide access to cloud-based content networking computation resources that enable event notification services, application and administrative services, and storage repository services based on user authorization and delegation assignments, (d) one or more computer servers that provide video stream file storage and archival transaction services to authorized users, (e) one or more computer servers that provide meta-data database management services to authorized users, (f) one or more mobile devices with elective privacy protection means operated by authorized users connected through network means to the cloud services data center that can capture and report on the geolocation of the device while it is observed by video cameras operating in the network, (g) one or more networked personal computers or mobile devices operated by authorized users connected through network means to the cloud services data center that can access and conduct transactions on video materials captured and filtered for elective privacy protection, or video materials captured and stored without privacy protection, and (h) all of the specified computers and devices capable of communicating and interacting with one other via the platform and networking configuration in an asynchronous manner on an ongoing basis. The computer servers and network infrastructure can have any number of variations.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter of this disclosure are contemplated as being part of the inventive subject matter disclosed herein. It should also be appreciated that terminology explicitly employed herein should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale, and in some instances, various aspects of the subject matter disclosed herein may be shown exaggerated or enlarged in the drawings to facilitate an understanding of different features. In the drawings:

FIG. 1 illustrates one embodiment of a community video security system (CVSS) supporting elective privacy protection capabilities.

FIG. 2 illustrates one embodiment of a configuration of cloud services for implementing serverless CVSS web and mobile applications hosted in CVSS data centers depicted in FIG. 1.

FIG. 3 illustrates one embodiment of deployment of CVSS cameras, sensors, and networks in a community of four neighboring RBUs and one common community area.

FIG. 4 illustrates one embodiment of deployment of CVSS cameras, sensors, and network in the community of FIG. 3 showing persons and vehicles moving about within the FOVs of some CVSS cameras.

FIG. 5 illustrates one embodiment of a scenario that can be viewed as denoting either: (a) a single community that spans across an open public space, or (b) two adjacent communities one on the left side, the other on the right side, separated by a public space.

FIG. 6 illustrates a close-up view the two-community scenario of FIG. 5.

FIG. 7 illustrates one embodiment of a configuration of control flow for CVSS methods.

FIG. 8 displays a FOV from one camera observing a stationary community registered motor vehicle in front of a RBU in a community.

FIG. 9 displays a FOV from another camera associated with the RBU seen in FIG. 8 observing the stationary community registered motor vehicle seen in FIG. 8.

FIG. 10 displays a FOV from the camera in FIG. 9 with an unknown person walking on a public sidewalk pathway adjacent to the stationary community registered motor vehicle.

FIG. 11 displays a calibrated camera FOV of RBU CAMERA 1 depicting a geofenced display region ABCD for motion, where a center spot with known GPS coordinates is indicated.

FIG. 12 displays a FOV for an opposing Camera 2 to the FOV of CAMERA 1 , with same center spot with known GPS coordinates of FIG. 11.

FIG. 13 displays a rectangular geofenced region ABCD of FIG. 11 projected as a trapezoid.

FIG. 14 displays a camera-based image with a FOV including an authorized community member detected within the geofenced display region ABCD of FIGS. 11 and 13 by a camera image motion processor that has applied an elective privacy protection cloaking filter.

FIG. 15 displays a person in motion within the geofenced display region ABCD of FIGS. 11 and 13 and enclosed in a graphic bounding box overlay, either without privacy protection mobile signaling device capability, or else with mobile signaling device capability but with privacy protection disabled.

FIG. 16 illustrates one embodiment of a method for CVSS Camera Pixel Geolocation Calibration (also for RBU Camera and Processor System Calibration Method).

FIG. 17 illustrates one embodiment of a method or Elective Signaling to Control Video Recording, and Content Filtering.

FIG. 18 illustrates one embodiment of a method for Electing Privacy Protection Filtering, Video Recording and Data Encryption.

FIG. 19 illustrates one embodiment of a method for Authorized and Delegated Access to Video Recordings.

FIG. 20 illustrates one embodiment of a method for CVSS Video Recording Archiving and Removal.

FIG. 21 illustrates one embodiment of a method for Continuous Processing Control Loop for Elective Privacy Protection.

FIG. 22 illustrates one embodiment of a method for processing of elective privacy protection passport and visa credentials.

### DETAILED DESCRIPTION

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

In general, platforms, systems, and methods are provided for identifying and privacy protecting authorized persons, vehicles, and objects in motion in the field of view of a video security camera or set of networked security cameras for use in a residential or business community. Various embodiments incorporate a security identification system that includes one or more mobile devices such as a smartphone or smartwatch, one or more cameras situated within a community with processors connected to data centers via the internet, and software running a cloud service infrastructure communicating to both the smartphone or smartwatch. The system can also include the ability to translate locational information from a smartphone or smartwatch into corresponding identification and geolocation information on images from security camera.

Locational information associated with the mobile device can be used to communicate signals to system data centers that control conditions during which the security cameras are electively instructed to record, not record, or to filter the recorded security video, prior to video encryption for transfer over the network. The ability to associate authorized persons, vehicles, or other objects in motion with registered mobile devices that signal their geolocation to the community video security system enables the provision of elective and resource efficient privacy protection capabilities to authorized persons, and also for their vehicles or other registered objects that can move about in their community.

### CVSS Platform and System Elements

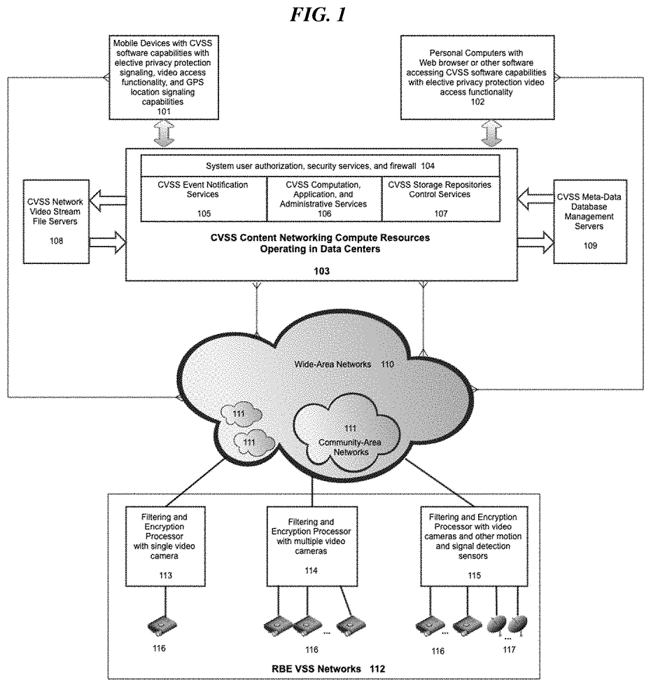

FIG. 1 specifies the composition and configuration of devices, systems, and platforms that collectively operate as a CVSS.

Such a capability at 112 allows for video security cameras 116 to capture video stream recordings that are filtered and encrypted by the respective processing nodes at 113, 114, 115 to which they are attached. These processing nodes are connected to either zero or more video networks at either 113, 114, 115, which are then connected to local area computer networks or mesh networks associated with a personal residence or business unit (RBU). Such data can then be communicated to remote or cloud-based software service providers either via community-specific data networks at 111, via wide area communications networks like cellular phone networks and the Internet at 110, or via both in interconnected network combinations at 110 and 111.

The data processing core of the CVSS represents a plurality of CVSS content networking servers that operate within data centers at 103 accessed either by community-based networks at 111 or wide-area networks at 110. These servers are protected by one or more system cybersecurity mechanisms, such as but not limited to multi-factor, role-based access control capability mechanisms and system server security firewalls at 104. These servers provide a variety of CVSS services including end-user and application event notification services at 105, CVSS computation and application services for CVSS administration and operations and other applications at 106, and CVSS video storage repositories control services at 107. These control services write and read video files for storage and retrieval from the video stream file servers at 108, and also create, read, update, and delete meta-data in a database at 109 associated with video stream files. For example, in a cloud-based data services center at 103, Amazon S3 buckets can be used to store video recordings at 108, while Amazon DynamoDB can store and manage descriptive meta-data associated with CVSS video recordings, as well as authorized user meta-data, both at 109. These storage repositories control services insure the synchronized creation, insertion, update, and removal of video stream files together with their descriptive meta-data, as well as coordinated with authorized and authenticated user access identification and privacy protection election data, and with descriptive data from users registered mobile devices and networked personal computers.

The CVSS computation and application services 106 provide functionality for all aspects of data content management, including data access control, data definition, data manipulation, and transaction control. These services also provide functionality for registering and authorizing end-users, and their associated mobile devices 101 and personal computers 102, that authorized end-users will employ to access data content and services, managed by the CVSS content networking servers 103, that are authorized and authenticated in order to pass through the server security firewall and related security service mechanisms 104.

The CVSS computation and application services 106 also performs all of the administration of the data center service and server resources, including CVSS server and operating system maintenance, capacity provisioning and automatic scaling, code monitoring and access logging. When the data center 103 is configured to operate on a high-availability compute resources infrastructure, like Amazon Web Services, Elastic Cloud, and Amazon Lambda, the data center service and server resources effectively operate as a cloud-based data center infrastructure, where services-based application program interfaces like Amazon API Gateway effectively replace traditional computer systems with serverless computation resources. This cloud-based infrastructure enables the CVSS platform to scale up to support CVSS deployments of different sizes in terms of the number and diversity of devices that can access it, along with the number of diverse authorized end-users with different privacy protection requirements. Alternatively, when the data center 103 is located within facilities servicing only a single community, the data center service and server resources operates as a conventional multi-tiered client-gateway-server network services platform that need only be scaled to meet the requirements of that specific community.

The video storage repositories services control and direct the video security recordings that are sensed, captured, filtered, encrypted, and transferred from RBU VSS networks at 112 over data communication networks at 110, 111. Descriptive meta-data associated with a video security recording is input from 103 to 109 to the CVSS meta-data database management servers, for storage and update in the database. Such database management servers may be hosted on common database software capabilities like Amazon Relational Database Service, Google Cloud SQL, Microsoft Azure DB, Mongo DB, PostgresDB, Oracle Database, or others. This meta-data includes but is not limited to the date, time, location, and duration of the video recording, along with data that indicates the detection of any privacy protected content in the recording. The video files, a sequence of video frames or limited duration continuous video stream, associated with its descriptive meta-data is input from 103 to 108 for storage and update in the CVSS network video stream file servers at 108.

End-users of the CVSS who are authorized to access certain video content that match their assigned CVSS access privileges, can send queries from either their mobile devices equipped with CVSS application software at 101, or personal computer at 102, to the CVSS database management system at 109 via data communications through the content servers from 103 to 109. The database management system at 109 in turn issues commands through the content servers at 103 to retrieve the files from 108 to 103 that match the query, for the associated video recording files stored in the video stream file servers at 108. The retrieved video files are then output to the end-user's mobile device from 103 to 101 or to their personal computer from 103 to 102.

Computational servers for CVSS software applications and recorded CVSS video security streams storage servers at 103, 108, 109, utilize data sharing network communication protocols that enable the transmission and exchange of data messages that encode information regarding video security camera observed or recorded events that are recognized and identified as persons, vehicles, or objects in motion along adjacent pathways within a residential or business community. These servers also provide application-level services to authorized CVSS community members accessed through mobile devices like smartphones running a CVSS mobile user application, utilizing data communications transmitted over the cellular phone networks or the Internet at 101, or networked personal computers running Web browsers that access software running CVSS application software, utilizing data communications transmitted over the Internet at 102. Input-oriented application-level services from 101 to 103 available to community members include the capability for a wirelessly networked mobile device carried or borne by authorized community members, member vehicles, or member animal pets, to utilize mobile geolocation signaling capabilities, for example those providing Global Positioning System, the Global Navigation Satellite System, and similar global geolocation systems (hereafter GPS) location coordinates, associated with the device running the mobile CVSS application at 101 to utilize CVSS application software to signal requests for geolocated privacy protection within the CVSS, while they traverse or move about within their community in areas subject to video security. Multiple mobile hardware devices at 101 have built-in location determination or homing capabilities that can accessed by CVSS mobile application software to wirelessly signal the GPS coordinates of their present location to other CVSS devices and networked services, while devices like smartphones and smartwatches at 101, as well as networked personal computers at 102, also add software application capabilities that can signal and determine the coordinates of a location displayed on a digital map rendered on the device's display. For example, the Google Maps application software available on smartphones from common smartphone vendors has the capability to wirelessly determine GPS coordinates based on the current location reported on the smartphone device equipped with a GPS microchip, or at a location or address indicated on a map it displays at user request, or via an open application program interface accessed by another software application. Output-oriented application-level services available to community members at 101, 108 include the ability to access, view, and share CVSS-based video recordings that coincide with their authorization.

CVSS content networking servers at 103 and their associated database management servers at 109 and video file servers at 108 may be remotely located in third-party facilities like cloud-based data centers operated by Amazon, Google, Microsoft, or other cloud-based data center service providers. Alternatively, these data centers may be located in private data centers specific to a community, or to a network of co-managed communities, such as those communities developed or managed by a large corporate entity. Input and output data communications services from 103 to 108 then back into 103, from 103 to 109 then back into 103, and from 103 to 109 and to 108 then back into 103, utilize common file transfer and network system operations software services. Alternatively, such servers may be collocated in facilities owned and operated by a community. The plurality of interconnected networks and data centers serve as platforms for multi-camera, privacy protecting video security systems and methods that monitor RBU communities via CVSS.

Next, CVSS provides services for community members to access, view, and share video recordings that capture, observe, and record their presence within the FOV of one or more CVSS cameras at 116. These videos can be accessed and processed using either a mobile device like a smartphone, smartwatch, or tablet computer at 101, or alternatively via a networked personal computer at 102. Application software associated with either can communicate and invoke services associated with the CVSS content networking servers at 103. Additionally, application software associated with either can communicate and invoke services associated with the CVSS RBU VSS network processing nodes at 112 through wide-area networks at 110, like that for cellular phone and data services, or with data networks associated specifically with their community at 111.

For community members, their vehicles can carry a wireless mobile device like a smartphone, smartwatch, or other digital processing device that can detect their geographic location using GPS-based means through a CVSS mobile software application at 101. This GPS based means can optionally include position enhancement technology such as Differential GPS or Real Time Kinematics. This mobile software application can monitor, detect, and report the GPS coordinates of the person or vehicle associated with the mobile device. The mobile device can also utilize a software application, or a physical security key that plugs into an open data communications port on the device, to serve as an encryption capability that encrypts and protects data prior to or during remote data communications over a wide-area network. A community member's animal pet or other object can similarly bear a GPS location device like an ultra-wideband tracking device that wirelessly signals its GPS coordinates on an ongoing basis that can be detected, monitored, and communicated by community members' mobile device to the RBU VSS network processing nodes at 112, or to the CVSS content servers at 103.

CVSS provides elective privacy protection services for authorized end-users who are community members. Members use privacy protection service capabilities they elect to effectively control, filter, and limit access to video recordings when they, the community members, traverse the FOV of one or more CVSS cameras at 116 as they move through their community. Such elective privacy protection service go beyond single choice opt-out and opt-in privacy preferences settings currently available in online computing services or applications. In CVSS, privacy protection capabilities can cloak out and filter video recoding sequences from networked camera processors at 116 to authorized persons mobile devices at 101 or networked personal computers at 102, across wide-area networks 110 and community networks 111, and through content networking resource servers at 103. Similarly, in CVSS, privacy protection capabilities can cloak out and filter video recoding sequences while the community member is within the field of view (FOV) of one or more CVSS cameras at 116, and thus from one camera's FOV to another camera's FOV. This capability directs a signaling command transmitted from the community member's mobile device 101 to filter and encrypt the video sequence that indicates the person is located within a GPS coordinate region that intersects with the area corresponding to the FOV of the CVSS cameras 116 and their associated RBU processing nodes 113, 114, 115 that are monitoring that geographic area. Once the member with their mobile device and privacy protection capability in effect leaves the FOV of the CVSS cameras, then CVSS cameras and processing nodes return to their normal operational mode of sensing, capturing, recording, and transmitting video sequences with motion detection events across data communication networks 110, 111 to the CVSS content servers 103. This video may be subjected to other processing, filtering, and encryption methods that do not require privacy protection while providing CVSS services, such as image enhancement, video data compression, video data format transcoding, and other routines. Any end-user of the CVSS who can subsequently access the video recordings, will not be able to view privacy protected video content. However, the CVSS mobile or personal computer application software at 101 and 102 allows the community member whose video recordings were filtered and encrypted to realize their privacy protection, can elect to selectively opt-in to invoke a multi-factor decryption method that allows the unencrypted video to be shared with third-parties of the community member's choosing. In this way, the community member controls and protects the privacy of the movements or activities that were captured and recorded by the CVSS in ways that cannot be overridden by a known or unknown third-party or by a CVSS system operator.

Persons, motor vehicles, or objects including animal pets associated with a specific RBU, that are registered or authorized members of a community can elect to have their CVSS recording cloaked and encrypted to protect the privacy of identified persons and objects associated with them. Video security event data, including sequences of video security camera recorded frames, clock-time and duration markings, street address location or GPS location, and the location tracking and identification of individual person(s) and objects in motion observed by each video security, and other descriptive meta-data are among the data encoded for transmission and exchange across the platforms. Similarly, descriptive meta-data profiles of persons, animals, and objects (e.g., automobiles, motorcycles, trucks, bicycles, radio-controlled vehicles or aircraft, mobile companion robots, security patrol robots) that are persistent or recurring participants in a residential or business community, and who engage in motion behaviors observed by the video security cameras in their community, can register with the community-wide security services provider or third party to have their observed behaviors cloaked and encrypted to provide privacy protections.

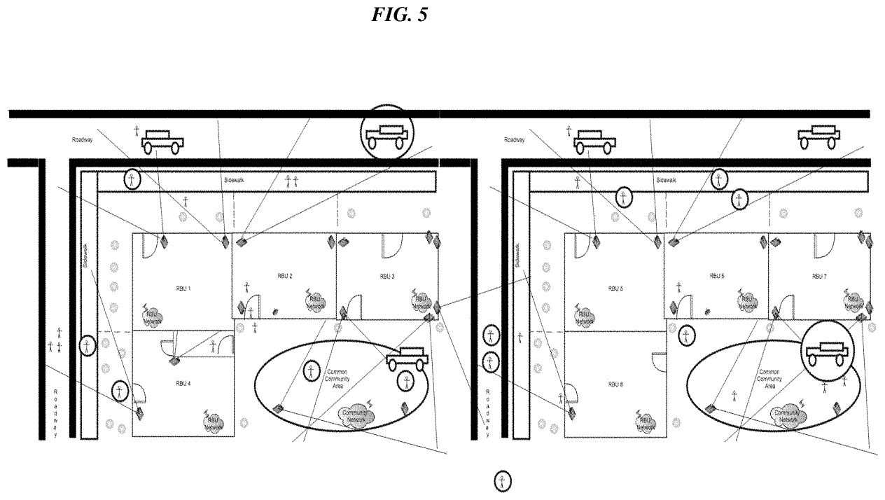

FIG. 5 illustrates a shared example depicting either (a) one community that spans a public space, or (b) two communities separated by a public space. The FOV of some cameras may be limited to short field depth or opaque objects like walls, while other cameras may observe FOVs with wide, long field depth.

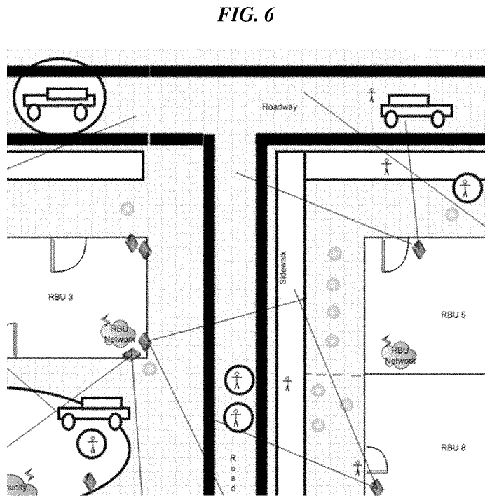

FIG. 6 depicts a CVSS camera associated with RBU 3 in one community on left side, and another CVSS camera associated with RBU 8 in an adjacent community on right side, with both cameras viewing common public space (roadway, sidewalks) in between. In this figure when denoting two communities, this creates potential conflict in privacy protection elections for members of one community who traverse open space in-between inter-community boundaries. Such conflicts are resolved through multi-community affiliations or networks that offer individual community members with an existing privacy protection passport to request, and be authorized to receive, a privacy protection visa for the specified adjacent community. These capabilities enable authorized residents of one community's CVSS to keep their elected privacy protections in effect across other community's CVSS, except to when the residents enter another community that has collectively elected to either not honor such passports, or that community revokes or constrains certain privacy protections for visitors who are currently authorized passport holders from another community. For example, a community member with a privacy protection passport from the left-side community, may traverse the public space in between, so as to enter the realm of the CVSS of the right-side community, and then further traverse into the right-side community into that community's common area, where the right-side community members have collectively elected to denote non-right-side community members as visitors, who may request or be granted a visitor privacy protection visa.

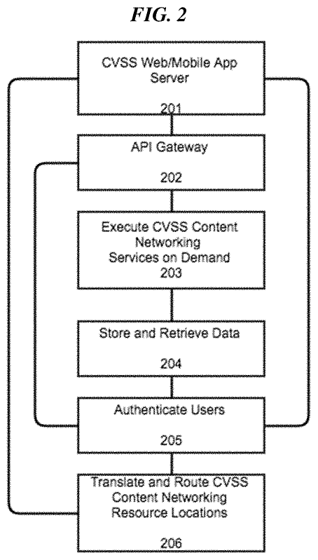

As shown in FIG. 2, the CVSS content networking compute resources can be configured for deployment in a cloud-based services manner that implements serverless CVSS web and mobile application services. Examples of non-limiting embodiments of these services can be realized using cloud-based infrastructure, platform, and software services available from cloud services providers like Amazon Web Services, Google Cloud, and Microsoft Azure. In a non-limiting example, CVSS mobile applications at 201 can be served upon access to Amazon API Gateway at 202, via software services invoked using Amazon Lambda at 203 for authorized users at 205 via Amazon Cognito, to receive notification of privacy protection election events made using smartphone devices at 101, where the mobile devices wide-area network address location identifier at 206 using Amazon Route S3 and authorized user privacy protection elections are signalled by users mobile devices at 101, then queried and retrieved at 204 from an Amazon DynamoDB database management system at 108, in order for users privacy protection election to be effected, for subsequent video stream recording captured, filtered, and encrypted at 112 for transmission to and storage in the CVSS data center at 103. Similarly, in another non-limiting example, an authorized user as above can utilize their personal computer at 102 with a networked addressed communicate to Amazon Route S3 at 206 to request to search for, select, and view CVSS video stream recording through a Web browser from the video stream recording via Amazon S3 video file storage server corresponding to the video recordings meta-data in an Amazon DynamoDB database at 204 that engages Amazon CloudFront to get the selected videos files from S3, via Amazon Lambda services running at 203. Continuing with this same non-limited example, the video recordings filtered and encrypted by the camera node processors that originate from either 113, 114, or 115 that were uploaded across wide-area networks at 110 or 111 into content networking compute resources at 103, must be queried via Amazon DynamoDB at 204 hosted on 108, then evaluated with CVSS software services implemented using Amazon Lambda at 203 to determine if the users authorization at 205 and personal computer network location address evaluated at 206 allows for access, decryption, and privacy protection filter election assignment in effect, prior to decryption and display for viewing on the users networked personal computer.

FIG. 3 shows an example deployment of CVSS cameras, sensors, and networks in a community of four neighboring RBUs and one common community area. As shown in FIG. 3, some RBUs have immediately adjacent RBUs. Other RBUs in the community are non-adjacent. For example RBU2 has two adjacent neighbors, RBU1 and RBU3, but RBU1 and RBU3 are non-adjacent. An RBU can also be adjacent to sidewalks, roadways, and common areas. The FOV for some of the cameras are indicated. Some FOVs overlap, and some have stationary objects like trees (appearing as shaded circles) that may partially occlude a camera's FOV. Other 116 cameras may have a limited FOV to observe, for example, a side door entrance to a residence from within an alley way between neighboring RBUs, where the FOV of the camera may have a short width and limited depth of field that is further delimited by a stationary wall. Such 116 cameras may be oriented so that their FOV does not observe the ground.

Each RBU has one or more video cameras 116 on their property. These cameras are oriented to view the property or entry/exit ways. Common areas have zero or more cameras also in effect. RBU cameras can observe activities on sidewalks and roadways adjacent to the RBU, including people and vehicles who use these sidewalks and roadways to move along. Cameras associated with an RBU may be wired or wirelessly connected to the RBU's data communication network 112, which in turn may be connected to either a community-wide network 111 or to another wide-area network 110 like the Internet. The angular FOV for some cameras is depicted. The FOV for adjacent cameras, whether or not they are associated to adjacent neighboring RBU, can sometimes overlap. But in other places, the FOVs of multiple cameras do not overlap. So a CVSS needs to employ technical methods for logically connecting the FOVs of adjacent CVSS networked cameras to create virtual panoramic FOVs within parts of the community. This can be achieved using known methods for topological analysis of images captured by multiple cameras observing overlapping and adjacent FOVs.

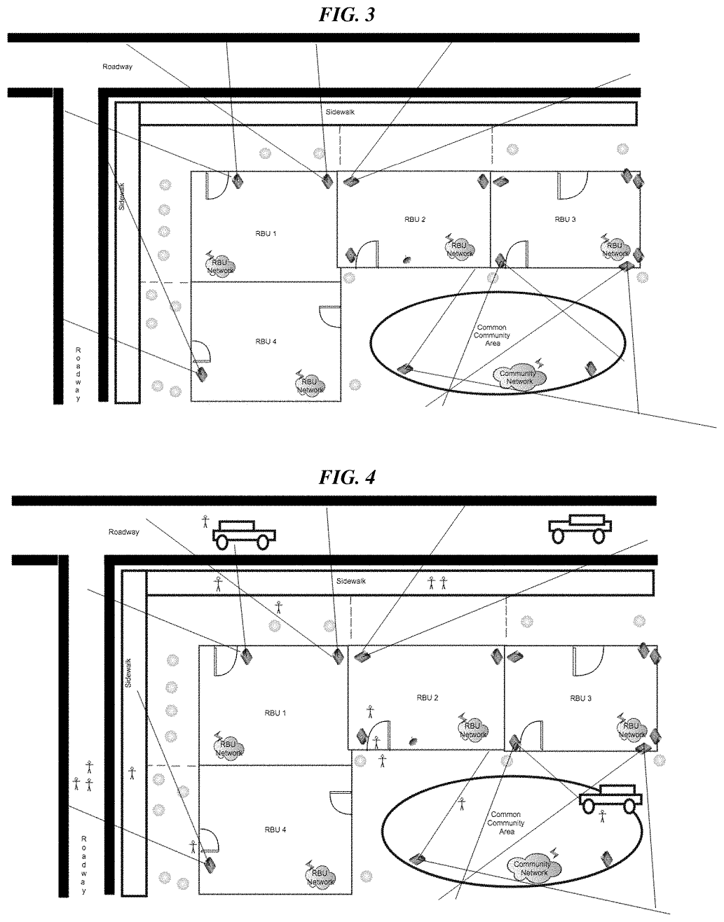

Beyond these capabilities, the CVSS optionally provides computational methods for recognizing and tracking individual persons, vehicles, animal pets, or other objects with motion behaviors observed within the FOV video cameras across a plurality of adjacent security cameras connected in a network. These methods allow for tracking individual persons, vehicles, or other objects with motion behaviors observed and identified by one video security camera and its associated processor to be re-identified and further tracked by other video cameras in the network at 112 along adjacent pathways. Identification is determined by detection of the privacy protection signals transmitted by mobile signaling device at 101 carried by a person, vehicle, or other objects as they move within a community. In this way, a networked system of video cameras 112 and 116 on different adjacent residences may observe and record persons, vehicles, or objects moving along common pathways like sidewalks, streets, or trails if they can be observed or seen in the FOVs of different video security cameras, as shown in FIG. 4.

Such a capability further provides elective privacy protection mechanisms that can assure the privacy of registered or authorized individual persons, vehicles, or other objects with behaviors observed by video security systems. This privacy capability when elected relies on computational services methods that cloak and encrypt the video recordings that capture the observed appearance or visual identity of such persons, vehicles, or other objects in motion like resident's pets. This capability is realized through a means for digitally cloaking identification data and meta-data that obscures or hides the visual content of camera-observed regions with motion detected content. Such capability is realized either at (a) the camera processor nodes 113, 114, 115 in a decentralized CVSS configuration, or (b) in the data center 103 in a centralized CVSS configuration, or (c) in joint decentralized and centralized CVSS configuration. The joint configuration is less preferable as an embodiment because of increased complexity and costs of maintaining both decentralized and centralized configurations thus less efficient resource utilization, while a community adopting CVSS may find that such a joint configuration offers greater backward compatibility to legacy VSS deployments. Other video camera observed content not identified for digital cloaking remains uncloaked, and may be subject to recording, encryption, and transmission across CVSS networks and into CVSS data center resources. Encrypted identity data and meta-data values may be decrypted by persons, service providers, police, or other judicial authorities who petition for decrypted access to such data and meta-data, using legal authorization like subpoenas or waivers of certain legal rights. Alternatively, authority to access to encrypted data and meta-data may be granted by registered known persons who by registering and accepting a privacy disclosure agreement can delegate the right to access such data or meta-data to others.

Referring again to FIG. 1, devices identified include: video security cameras 116; (optional) non-camera based object geolocation and motion detectors 117; common wireless mobile devices like smartphones, smartwatches, or tablet computers with GPS geolocation capabilities 101; and common networked personal computers and smart televisions 102; any or all of which are connected to local area RBU networks 112, community-wide networks 111, the Internet 110, to access and update video recordings and descriptive data at CVSS data centers.

Networks include: those specific to an individual RBU or a common community area, networks 112 connected to RBU-based video security cameras and (optional) non-camera motion detectors (hereafter RBU VSS networks); community-wide networks 111 compatible with the Internet; wide-area networks 110 like cellular phone networks connected to community-wide networks and to the Internet; and internal networks within the CVSS data centers 103.

Software services include computation, application and administrative services 106, and event notification services 105, and data storage servers 107 connected to these networks are associated with CVSS applications that input or output CVSS managed data to authorized users via wireless mobile devices 101 or personal computers 102. The CVSS networked servers that host cloud-based software services shown in FIG. 2 are situated to operate within cloud-based data centers 103, whether hosted by open cloud services providers like Amazon, Google, or Microsoft, or else hosted on a private cloud in a community's facility. These servers are defended from unauthorized access via system security service capabilities 104 that control, restrict, and record access from remote mobile devices or personal computers to those registered, authenticated users 205, and are capable of presenting digital credentials that allow passage through role-based user access control capability system security services and firewalls 104. These software security service capabilities utilize, but are not limited to, security methods like multi-factor authentication 205 to control user or remote network access, and verifiable methods that record such accesses using distributed ledger data structures, for example, using a blockchain and associated processing methods at 109.

Data 204 that is input to or output from data center servers 103 via mobile or web-based devices 201 can be associated with event notification services 105. Notification services capabilities are ubiquitous across the CVSS and its data storage repositories 107, like those indicating, for example: an authorized community member is moving through their community and has elected privacy protection; unauthorized person is attempting to access CVSS video records and such access should be denied; or that an authorized community member has requested temporary authorization for a visitor to receive privacy protection visa prior to arriving and moving within the community for an established period of time. Other data input and output are video stream recordings are managed by CVSS storage repositories servers 108 that separate the video stream recordings as files for storage and subsequent authorized user application service notification requests, from the meta-data associated with individual video stream recordings 109 such as start/stop times, recording duration, camera location and its associated RBU address, privacy protection on/off status, and more. Video stream recordings are stored as data using networked file servers 108, while video stream meta-data are stored and managed via a database management system 109 that maintains relations between the descriptive meta-data and the video stream record specified by such meta-data.

Other CVSS application services 201 associated with CVSS operations, user account management, third-party access control, and other community services are handled 202 and managed by application software specific to those capabilities 203, 204, 206. These services are common to the operation of Web-based or Internet-based application services that access and control data flowing into or out of a networked software application for a set of authorized users 201, 205, 206.

### Overview

Both professional and community volunteers may be involved in visually monitoring, observing, and potentially reporting the activities of people, vehicles, animals, etc. that do not appear to belong to community members, as well as common hazards like fires or events at community facilities. Professional security service providers can be contracted by a community at significant cost to provide security personnel in uniforms and vehicles, or to observe and report on activities observed in VSS display monitors. Informal community groups who setup a Neighborhood Watch activity rely on community volunteers to observe and report suspicious persons or events. However, as unpaid volunteers, their attention may be partial or infrequent, and thus their provision of security services is partial and unreliable, or worse, sometimes voyeuristic or discriminatively targeted to people who appear different, or who may be disliked by the watchers. Providing these volunteers with access to a shared community VSS generally does not improve community security for these same reasons. There is a clear need for community security services that are low cost and efficient, that are on-duty continuously and highly reliable, and that can observe and report security threats or transgressions within a community, but do so in ways that respects and protects the privacy of community members, while also reducing the potential for VSS abuse.

More capable VSS can filter video content to primarily record scenes with moving objects within the camera's FOV. Many low-cost wireless cameras with such capability are available like Amazon Blink, Arlo Go, Google Nest, Amazon Ring Video Doorbells, Wyze Cam, recycled smartphones with cameras, and a large category of such cameras commonly called spy cameras. In this way, VSS observed movements trigger a motion detection event, potentially indicating something of interest has occurred that is associated with the movements detected and recorded. Such selective recordings do not record other segments of the video stream, such as when no moving objects or motion is detected. So-called doorbell video cameras and other security cameras, connected to home computer networks or remote third-party security services networks, are equipped with automated motion detection and event notification capabilities. Such events can be recorded and labeled with indices that facilitate their selective retrieval by the VSS end-user. However, even with such selective event recording capabilities, any moving object observed by such a security camera such as wind-blown debris, birds flying by, insects that fly about or crawl over a camera, sun-based or street-lighting shadows whose projection varies in time, and other motion detection artifacts that generate many false positive security event notifications, and thus waste system resources. Such notifications signal events that contain motion but not a security threat or intrusion. New cameras that incorporate passive infra-red detection, filter motion detection events to those that contain some heat-bearing object like a human, animal, or vehicle are an improvement, but they still can generate false positive motion detection events. Overall, these security methods, devices, and systems potentially generate a high rate of false security threat event notifications. This in turn results in low-quality, inefficient, unreliable, or unpredictable security threat event notification. There is a clear need to overcome these VSS technical weaknesses in order to improve the value, efficacy, and efficient system resource utilization of a networked VSS.

When professional security services personnel are employed to observe such security video streams, they often can recognize known residents and authorized personnel entering an area that is under video surveillance who are not a security threat. They also recognize unauthorized or unknown persons as a potential intruder or other security threat. So residents, businesses, and others that employ individual or plurality of such security cameras that rely on automated motion detection event notifications, fail to realize effective video surveillance security that correctly detects and identifies authorized persons, while also identifying unauthorized persons as possible intruders or security threats within an area under video surveillance. Again, there is clear need to overcome these missing capabilities in order to improve the value, resource efficiency, and efficacy of a networked VSS.

Some VSS and devices like doorbell cameras and entry-way cameras connected to the Internet, or to private security services providers, offer basic video recording, networking, and remote access to authorized users, while accommodating networked sharing or export of video recordings. These systems and devices provide modest video surveillance capabilities, mainly those targeted to individual homeowners, household residents, or small business owners. Other VSS employ video surveillance as a service (VSaaS) capabilities that support cloud-based video streaming, storage, and image processing software methods, such as machine-learning based object recognition based on object image training data sets. Such VSaaS capabilities are valuable but not sufficient. For example, when certain kinds of potential security problems or concerns arise, they are not tracked, recorded, reported, or handed-off in a consistent way, if at all. This can arise when: (a) an unknown person or persons trying to enter or open entry/exit doors into a residence that may be locked/unlocked; (b) when an unknown person approaches a residence to pickup a package left outside; or (c) when such unknown persons move from house to house, or to and from businesses and adjacent businesses. Similarly, VSaaS system solutions do not address privacy protection during video image capture and recording, instead these solutions rely on the absence of privacy protection capabilities. Furthermore, if VSaaS systems rely on live video (and audio) streaming to observe and record security threats or events while they are occurring, available live streaming data communication protocols lack capability to distinguish authorized persons seeking privacy protection from those who are not authorized or don't seek such protections. This resource inefficiency arises with open User Datagram Protocol used with WebRTC applications like Zoom and others, along with proprietary video streaming protocols like HTTP Live Streaming used with YouTube, as well as alternatives used on Amazon, Microsoft Azure, Twitch and others.

Internet video sharing sites like YouTube, Instagram, Vimeo, Facebook, and others provide open access to recorded and shared residential doorbell camera videos observing suspicious persons in action. But the videos also make clear that the security capability in effect is primarily a video recording that documents in some way what the camera captured, where such a video recording can be posted and later shared across a network with interested viewers, police officials, or remote security services providers. Thus, with these devices or VSS, there remains the need for someone to watch the video recording to determine if there is a security threat event, and to report their observations and any related descriptive information to police, security service providers, or nearby community members. These VSS and devices therefore lack the ability to distinguish known residents, authorized residential service providers, welcome visitors and community members, from persons that are unknown or unauthorized, and do so in ways that protect the privacy of community members based on their own choices, while capturing and recording the activities of non-members. Once again, there is a clear need to overcome these missing capabilities, as well as the inefficient use of system resources and personal attention, in order to improve the value and efficacy of a networked VSS.

Conversely, neighbors and other people who reside in, or routinely work in, a residential or business community often express concern for their perceived loss of privacy when they are observed and recorded by extant VSS. While modern VSS offer advanced security monitoring functionalities, these capabilities can be perceived as a threat to the privacy of those recorded in the video. It is therefore important that the deployed capabilities of VSS strike a balance between shared choices for community security and personal choices made for when and where to protect individual privacy. At present, VSS lacks methods, features, or capabilities that enable residents, neighbors, or other people who live or routinely work within a community to electively opt-in or opt-out of multiple differentiated privacy protection capabilities.

A community is a group of people who own or occupy personal residences or business units (RBUs) within a bounded geographic area. Communities have shared common interests. RBUs are commonly adjacent (neighboring properties share a property boundary) or are located in close proximity, and their owners and occupants share, value, debate, and protect their common interests. These interests are associated with community safety, sustaining, or improving RBU property value, maintaining common properties and facility services, insuring the security of community members and their physical properties like residential homes, or shared community facilities like parking lots, clubhouses, or pools that lie within common community areas, as well as the larger geographical perimeter boundary defined by the community. These common interests are administered through an organizational body that provides governance services including collection of membership fees, issuance and update of community oversight policies, community security services, and more including repair, maintenance, and operation of community resources and shared facilities that represent properties owned or managed by the community. Such communities may be formally constituted and governed via a homeowners association, residents association, community association, multi-tenant industrial or business park association, multi-building campuses, school campuses, or similar. Communities are thus constituted to serve their members, to provide reasonable and compliant safety protections, and to protect the security of RBUs and shared properties. Yet communities that deploy VSS are challenged for how to respect and protect the privacy of community members who are otherwise routinely observed and recorded by a VSS deployed in their community. But current VSS lack technical ways and means for providing privacy protection capabilities that can be electively configured by community members to best meet their privacy protection preferences (current privacy settings) and choices (decisions to change privacy settings).

Communities are not the same as a government municipality. They do not have publicly elected officials and public employees who provide common municipal services. Some communities may partially or fully overlap with a government municipality. Communities may hold elections whereby community directors or board of directors are elected for a fixed term by community members. Community directors may be authorized by community members to formulate community governance policies regarding community membership fees, insurance and upkeep of shared community facilities like pools, parking lots and clubhouses, community-wide security services, and more.

Some communities advocate and practice shared community surveillance efforts through informal means like online message notifications using Facebook groups, neighborhood Twitter feeds, or Internet-based Nextdoor application software. Some communities advocate and practice shared community surveillance efforts through more formal, organized means like Neighborhood Watch in cooperation with local police departments. Some communities engage third-party security service vendors that provide uniformed security patrols on a fixed schedule or ongoing basis. Some of these vendors install, operate, and monitor VSS through contracted service agreements with the board of directors on behalf of their community. At the same time, community agents are engaged to observe, document, report, and share records of unfamiliar persons, vehicles, or other objects in motion such as wandering animals, autonomous or radio-controlled vehicles, rolling or tumbling trash containers, mobile robotic devices, and low-flying aerial drones associated with safety hazards, security events, or disruptive transgressions within their community. Communities thus seek ways and means to keep their RBUs, shared facilities, and public thoroughfares that connect them secure, actively monitored, reliable, trustworthy, and privacy protecting.

Communities that set up a community-wide VSS (hereafter, CVSS), or contract to a third-party to provide CVSS monitoring services, have residents who want their privacy protected while also wanting personal safety and property security. Communities want to maintain the personal privacy of their residents when engaging in ordinary movements, gatherings, interactions, or work activities in or around RBUs in the community that do not represent a safety or security threat event. Community members want freedom from surveillance in general, but want security on an enduring basis. But different people within a community will decide conditions for when and where they want to opt-in, opt-out, or change their current privacy protection settings, even when elected privacy protections differ from the security needs preferred by other community members. For example, communities may want to insure that demarcated property regions or entry/exit thresholds are not trespassed and thus to accommodate video recording of trespassers, even by persons who are otherwise authorized for general community wide privacy protection. Privacy protection does not confer the right to trespass, to engage in criminal activity, or to otherwise evade established community guidelines. As above, there is a clear need to overcome these missing technical capabilities in order to improve the value and efficacy of a networked VSS designed to serve the elective privacy and security requirements of a community, and do so in a resource efficient manner.

When VSS from different, independent security system providers are installed and used on adjacent houses or businesses, there is typically no data exchange across multiple service provider devices or systems. Thus possible security threats captured as VSS observations of unknown or suspicious person(s) are not tracked and reported between or across such security service providers. Instead, individual neighbors, residents, business owners, or business employees must provide the missing capability to monitor, track, and report potential suspicious person(s) to one another, to the police department, or others. Such efforts are generally cumbersome, demanding real-time human attention and review of video surveillance system or device recordings, suspicious person(s) identification and description. As before, such time and attention resources is scarce, while the cost to employ personnel to monitor, observe, and report suspicious activities or other security threat events is high. Once again, there is a clear need to overcome these missing capabilities and resource inefficiencies in order to improve the value and efficacy of a networked CVSS.

When privacy protection capabilities are considered for use with VSS, such capabilities are either all or nothing. People subjected to VSS seek the prohibition of surveillance in designated areas like dressing rooms, restrooms, bars, sex-oriented meeting places, and even public commons. For example, the American Civil Liberties Union argues against the efficacy, and for the prohibition, of VSS in public areas, since in their view, VSS serve as a means for privacy invasion, search without due process, and societal control under the guise of improved physical security. More generally, different people want greater or lesser levels of security and privacy, at different times and in different locations. Technological responses have begun to add means to obscure, redact, de-identify, make invisible, or anonym ize the visual identity of all persons observed by VSS. But such responses decrease the potential security benefits of the VSS, yet increase the privacy protections afforded to the people moving in public areas. Thus, there is need for new solutions that can selectively provide ways to balance the security benefits of a VSS, while also maximizing the privacy protections afforded to the substantial majority of people whose activities and movements do not represent a security threat or criminal transgression, in accordance with the preferences of the people within a community in a resource efficient manner.

Some video surveillance systems utilize artificial intelligence ways and means to identify persons under observation through techniques like facial recognition. It might be possible to develop and deploy a facial recognition based CVSS that seeks to visually identify and distinguish authorized community members, their vehicles, and their animal pets from those of non-community members. However, facial recognition has numerous downsides. Fairly high resolution video imagery can be required for it to operate correctly, while clothes a person wears can be styled or adorned in ways that partially or fully occlude a person's face, which can cause facial recognition to fail. Furthermore, facial recognition techniques require a database of faces for system training and machine learning. If one is interested in some form of privacy protection of individual persons, then these techniques present a significant hurdle to achieving that goal. The system described herein does not utilize nor rely on such techniques.

The subject matter described herein generally relates to CVSS platforms, systems, and methods in FIG. 1 and FIG. 2 to facilitate authorized users identification in an elective privacy preserving fashion wherein a smartphone or smartwatch communicating over a network via 101, and one or more cameras 116 communicating over a network 112, can work together such that persons in the FOV of a video security camera can be identified by an CVSS as possessing and utilizing a wireless mobile signaling device 101 to electively specify their current privacy protections, while observed in motion by CVSS networked cameras in a community, and do so in ways that are able to combine data from both sources.

FIG. 1 presents a non-limiting example of an CVSS 100 that facilitates identification and recognition of an authorized persons, vehicles, or animal pets or other moving objects as users that are carrying or bearing a wireless mobile device 101 that can detect its GPS location coordinates, broadcast a signal that encodes the identity of the user and geolocation of the device, that can signal an elective opt-in or opt-out request for privacy protection video sequence filtering and encryption, as illustrated in block-diagram form.

FIG. 2 presents a non-limiting example of a configurational scheme for CVSS content networking services for implementing serverless CVSS web and mobile applications. All service interconnections accommodate data input and output flows.

### Data Network

In embodiments, the CVSS System 100 includes Data Networks 110, 111, 112, which is a set of hardware, software, interconnected networking equipment, and data transfer protocols configured for electronic communication. These networks may be configured into common interconnection schemes that include local area network, wide area networks, peer-to-peer networks, cellular service networks, data center networks, or mesh networks that are realized through wired or wireless means, known to those skilled in the art. These networks may further be physically or logically configured into topologies that represent star, ring, bus, mesh, or hybrid network schemes.

In preferred embodiments, CVSS data centers 103 also utilize internal data networks that further configure the CVSS content networking compute resources into either serverless data processing cloud services, or monolithic compute server networks. These networks support data communications protocols and processing capabilities common to use of the Internet such as TCP/IP, UDP, FTP, HTTP and others. Further, cloud-based serverless compute services that can be driven by event notifications may be hosted using AWS Lambda and Amazon API Gateway, or competing online service capabilities. Any data transfer or data processing command sequence transmitted over the Data Networks 103, 110, 111, and 112 within the CVSS System 100 is able to be secured through digital data encryption, access control capability lists, user authentication, or other mechanisms that provide cybersecurity protections and information integrity assurances. For instance, in embodiments that utilize remotely hosted data centers like those for Amazon Web Services (AWS) and Elastic Cloud (EC2), Amazon Cognito and AWS Secrets Manager provide such functional capabilities. Next, Data Networks 103, 110, 111, and 112 may be any one of a global data network like the Internet, an application content or services network operating on a data network (e.g., World Wide Web), a regional data network, mobile/cellular wireless network, or a local area network. In a preferred embodiment, Data Networks 103, 110, 111, and 112 represent a packet-switched network utilizing common Internet Protocols to transfer and route various data, including application content or services. The Data Networks 103, 110, 111, and 112 use common high-level protocols, such as TCP/IP and may comprise multiple networks of differing protocols connected through appropriate gateways. The Data Networks 103, 110, 111, and 112 may also utilize cybersecurity protection capabilities like virtual private networks, two-factor authentication, zero knowledge encryption password keys, and sharable video file link access keys, as well as optionally blockchain-based distributed ledgering for maintaining the integrity, traceability and provenance of data transactions or command processing transactions.

In a preferred embodiment, common existing data communication networking means such as those utilizing Internet Protocols, video streaming control flow, and common networking services for file transfer are employed, whether for RBU networks at 112, community area networks at 111, or wide area networks at 110 like the Internet. To further support mobile devices that utilize wireless cellular phone service networks, such devices may utilize common cellular network services that communicate through wide-area retail phone network at 110 service providers like ATT, Verizon, Sprint, T-Mobile, or others to communicate with CVSS content servers or camera processor nodes to affect CVSS application services.

In a preferred embodiment, all networks and devices specifically configured to support encoding, transfer, decoding of CVSS video data file streams employ common streaming data protocols like RTSP, RTMP, HTTP Live Streaming (HLS), Low Latency HLS, Dynamic Adaptive Streaming over HTTP, or others known to those skilled in the art. All data transmitted over the networks is subject to processing and protection via data encryption means using common means known to those skilled in the art, such as associated with Transport Layer Security, Advanced Encryption Standards like AES-256, or others.

### CVSS User Authorization, Security Services, and Firewall

In a preferred embodiment, all CVSS system users must be registered and entered into CVSS server data bases through user administration services at 106 using personal data that establishes their online identity. Registered users must then access the CVSS through network means 110, 111 using an authentication protocol and capabilities that communicate user access data credentials through 104 from their mobile device 101 or networked personal computer 102. Every user will have an online CVSS security data profile that incorporates both community membership information along with mobile devices or personal computers they want authorized to access CVSS applications and elective privacy protection capabilities. Part of this CVSS security profile is stored and encoded within each member's privacy protection passport. Communities may determine different groups of user membership, along with which members can invite non-community members to temporarily access CVSS applications and capabilities while in possession of an operational and active privacy protection visa, while visiting the community.

In a preferred embodiment, all data that is transacted and transferred across CVSS networks 110, 111, 112, as well as those networks internal to the CVSS data center, is secured by encryption prior to network transfer.

In preferred embodiment, user authentication, security services, and firewalls at 104 control access by users, CVSS applications, and CVSS services to all CVSS data that is entered, captured, filtered, encrypted, transmitted, stored, retrieved, decrypted, and displayed via CVSS. Users access and invoke CVSS applications and services from mobile devices at 101 and networked personal computers at 102, and this access may be through virtual private network software running on those devices, personal computers, and CVSS data centers, across the networks that connect them, such as 110. Unrecognized, unidentified, or not currently authorized users are prevented from accessing and using the CVSS when denied access via the virtual private network, as well as through user authentication capabilities at 205. All video stream recordings that are captured and transmitted from the camera-processor nodes at 112 are subjected to elected privacy protection filtering assignments, and to key-based data encryption prior to transmission to the CVSS data center at 103 via wide-area networks at 110 or 111. Video stream recordings and associated meta-data for video recording content, users, and user access means at 101 and 102, may be further encrypted in the data center using other key-based schemes, optionally including those based on blockchain computation services at 106.

In a non-limiting example implementation, cloud-based services like those supported by Amazon Cognito at 205 can be used to authenticate different categories of users, including community members, visitors, property managers, and system administrators. Authentication can include provision of role-based user access control lists that specify what CVSS services and application capabilities are assigned to different users. Data stored and managed by CVSS storage repositories services at 107 can be encrypted and decrypted using keys managed using AWS Secrets Manager through CVSS services coordinated via Amazon Lambda at 203.

### CVSS Content Networking Servers and Services

In embodiments, video recordings are video image sequences captured and recorded by RBU cameras 116. These video recordings are captured as digital storage files that are filtered and encrypted by camera processors 113, 114 or 115, or else by computational applications 106 in the CVSS server data centers 103. The video recorded image sequences organized via 107 into files 108 with descriptive meta-data 109 are a principal kind of data that is transacted and transferred 206 across the CVSS networks 112, 111, 110, as well as stored in CVSS repositories 108, 109.

Data that characterizes all system users, their authorization and access privileges, their retrieval queries, CVSS event notifications via 105, and other descriptive data that originate in user mobile devices 101 and networked personal computers 102, are also a kind of data that must be routinely communicated across CVSS application servers 201 and data networks 110, 111, 112.

Video recording files retrieved 204 by authorized users 205, who input or select corresponding descriptive meta-data, for playback and viewing 203 on user mobile devices 101 and networked personal computers 102 are also data that is transacted and transferred 206 across CVSS application servers 201 and data networks 110, 111, 112.

All of the preceding data communication networks may involve the use of either local-area and wide-area networks for data transactions and transfers 110, 111, 112. The communication of such data may precede or follow data access, update, or security events that originate within notification services associated with pre-specified event types managed within CVSS data centers 103, within the mobile devices 101, or within personal computers 102.

CVSS data centers 103 utilize internal operations data communication networks within their centers to transact and transfer video recordings and user data 204 among and across computation and data servers internally accessed using CVSS services APIs 202, including CVSS database servers 109 and file servers 108, operating within the CVSS data center 103.

Overall, data transferred across CVSS data networks 110, 111 is encrypted prior to transfer at 101, 102, 113, 114, 115, in conjunction with methods described below for electing privacy protection, video recording and data encryption.

### CVSS Database and File Servers

In embodiments, database management systems (DMS) known to those skilled in the art and employed for use in CVSS at 109 include those commonly identified as relational DMS, NoSQL DMS, hierarchical DMS, or graph-based DMS. Alternative embodiments may accommodate the use of flat file storage schemes, in-memory schemes, or even spreadsheet-based data management capabilities to provide DBMS-like processing capabilities. DMS commonly manage the organization, storage, and update of data via transactions commonly initiated by DMS users or database administrators, for data stored on secondary storage devices such as hard disk drive, solid state drives, tape drives, or network attached storage. Authorized users of CVSS may thereby be able to search, query, retrieve, and display CVSS managed data using their mobile devices 101 or networked personal computers 102 using CVSS application software services provided for such means.

In embodiments, the CVSS System 100 includes a CVSS Database 109 and one or more video file servers 108. The CVSS Database 109 can utilize available DBMS software such as Amazon DynamoDB, Google Cloud SQL, GraphDB, Microsoft SQL, Neo4J or others, while the file servers 108 can utilize available software systems such as Network File System, Microsoft Azure File System, Google Cloud Storage, or Amazon Elastic File System. The CVSS Database 109 and video file servers 108 may utilize any type of storage device or storage medium such as remote cloud storage, network attached storage, local hard disk storage drives, compact disks, removable storage cards, and may also include a collection of devices, for storing and organizing data arising from CVSS System 100 usage and operation. Similarly, it should be understood that CVSS Servers 103 and CVSS Database 109 and video file servers 108 optionally reside on the same computing device, or on different computing devices connected through a data network in a data center 103. Additionally, every community that utilizes a CVSS may do so with its own separate set of content networking servers 103. This accommodates multiple communities to engage in scalable data communications and exchanges across wide-area networks to support services that benefit from inter-community networks, such as shared event notifications for events that denote security or privacy protection requests that traverse adjacent or multi-community boundaries, or open areas in between nearby communities.

In embodiments, the information stored in CVSS Databases 109 and video file servers 108 is securely accessed, created, read, written, queried, updated and removed through its connection to the CVSS Servers 103, which in turn communicates with other CVSS System 100 components over the Data Network 110, 111, and 112, through respective network connections, represented as solid lines in FIG. 1. Access control security to the database is realized through means such as user and role-based access control, and object schema transaction access processing capabilities. The network connections are wired or wireless, and are implemented using common data communication protocols. CVSS Database 109 and video file servers 108 stores electronic files representing video sequence recordings of people, vehicles, and animals as they move around a community that were captured and processed by the CVSS cameras 116 and processor nodes 113 or 114. Further, the camera processor nodes may include secondary storage capabilities, so as to realize digital video recorder (DVR) or network video recorder (NVR) capabilities, that allow for authorized users to access, view, or remove video stream recordings stored within the DVR/NVR via a registered mobile device or networked personal computer.

In a preferred embodiment, CVSS Database 109 manages meta data that represents an authorized user database storing such information as community member user id, contact information (email address), globally unique identifier (GUID), authorized times, type of user (resident, owner, vendor, visitor, etc.), privacy protection passport/visa status, current privacy protection elections for a user, and other user profile data. In the same embodiment, CVSS Database 109 also have event logs that store detected persons and identification status (identified or not identified and associated user info).

In preferred embodiment, CVSS Database 109 stores information about each camera that is connected to it including but not limited to: camera ID, camera type, camera name, camera or camera processor MAC address, processor IP address, camera geolocation coordinates, associated/nearest RBU physical address, and GPS receptive field. The GPS receptive field is information describing what physical area the camera observes via its FOV, in terms of a set of GPS described coordinates.

### RBU Camera and Processor System

In a preferred embodiment, each RBU Camera system 116 can be an ordinary wireless or wired digital video camera capable of capturing and transmitting video image sequences or streams to another device or processor node 113, 114, 115 for further data operations. Example video cameras include but are not limited to image capture means via visible light, infrared (IR) cameras, cameras with pan-tilt-zoom (PTZ) functionality, depth of field cameras, video cameras with forward looking infrared (FLIR) or passive infrared (PIR) detection capability, or even image type generating devices such as providing light detection and ranging (LIDAR) capabilities. An RBU, or a community common area, may have one or more cameras 116 attached and associated with it. Cameras and processors may also have a physical location address associated with it. Optionally, a community may have RBUs, or community common areas, that have zero or more cameras 116 attached and associated with it.

In preferred embodiment, cameras 116 are each packaged with digital processors 113 that include some video recording storage capacity and support visual image processing capabilities like those for automatic visual motion detection, so that the cameras only are capturing and recording when something is moving within the camera's FOV. Additionally, the processor may utilize its storage to hold a continuously updated buffer of video recordings for short duration of time, such as the past four seconds of video recorded. Such a capability allows for capture and recording of video sequences associated with some detected event like a person moving into the camera's FOV, together with the few seconds of video recording that proceeded the detected event. If PTZ cameras are employed, then additional calibration procedures must be utilized to accommodate PTZ range variations in the FOV. Such a video recording sequence is then subject to privacy protection filtering and encryption before transmission across a CVSS network 110 or 111. Otherwise, when nothing is detected as moving in the camera's FOV, the camera processor's storage buffer will not be storing video without motion for further processing by the CVSS. This capability helps improve overall system resource utilization efficiency.

In preferred embodiment, cameras 116 are packaged with or connected to digital processor nodes 113 that can be used collectively as networked video imaging sensors that can form an RBU video network 112. Cameras in such a network can be remotely controlled to electively filter, encrypt, and transmit video data streams at 113 over the data network to which they can communicate, such as the data network located at community members RBU 112, or over a community-specific network 111, or a wide-area network 110. The camera and processor are utilized to collectively determine the FOV to an activity zone or geographical area of interest. A camera's FOV can be digitally represented using geofencing means. Geofencing is a means to denote an outline or virtual perimeter of a geographical region of interest that the camera visually observes with its image sensor. Camera image pixels within the geofenced FOV region can then be associated with geolocation position coordinates. Given that cameras are installed and operated in fixed locations attached to, or positioned near, an RBU in a community, the geometric center of a geofenced region within a camera's FOV can be assigned to its terrestrial GPS location coordinates. Furthermore, a camera's FOV may contain one or more geofenced regions of interest for monitoring by cameras and their processor. Geofencing functionality associated with cameras and their processors can be used to situate the location of an authorized CVSS user's mobile devices 101 to determine whether they are within the geofenced region or not, when users have elected privacy protection.

In preferred embodiment, the CVSS utilizes low-cost digital cameras at 116 with processing nodes for the RBU video networks at 112 that are located within a one camera, one processor device enclosure at 113. The processor node supports common wireless data communication networking capabilities to communicate data and processing commands via local area networks associated with an RBU. Either the RBU local area network, or a network of multiple camera-processor units, may communicate to a common data networking appliance like a router, gateway, hub or mesh connection point. Such an appliance is also capable of detecting wireless signals and processing commands from authorized mobile devices running CVSS application software services that support privacy protection capabilities. Mobile devices at 101 supporting such application software and privacy protection capabilities include smartphone or smartwatches equipped to monitor and detect GPS signals that enable the CVSS application software on such devices to detect and transmit GPS coordinates while in the FOV of one or more CVSS camera-processor units. Mobile devices at 101 and personal computers at 102 are utilized to access, view, or share CVSS recorded video segments that the community member has authorization to do so. Only a community member who has elected to invoke privacy protection capabilities via their mobile devices at 101 or personal computers at 102 can access, decrypt, unfilter, view, and share video sequences that observe and record their presence by CVSS cameras and processors. This capability enables authorized users to verify that their privacy protection elections were in effect while they moved about within their community, were observed by CVSS cameras, and that their privacy protection was provided.

In embodiments with Single cameras 116 each with single processor node 113, the system provides minimal baseline surveillance capabilities to detect and filter the video recording of authorized people and vehicles. Persons and vehicles within a community that are associated with CVSS user authorization identifiers, low-energy Bluetooth signal beacons or ultrawideband signal beacons, transponders, or other identity broadcasting devices capture video streams where their visible identity and motion behavior are filtered via digitally cloaking means (blocked, obscured, made invisible to recording, etc.), and any video surveillance streams with cloaked persons or vehicles are encrypted prior to network transfer, storage, or broadcast to others. Encrypted video records may be decoded only by parties authorized to conduct or participate in security or police services, including persons designated as authorized to observe or report on activities or behaviors captured in video streams. For example, adult residents with families may want to access and view video stream recordings captured by specific cameras to monitor the safety of their children and activity behavior of family elders in shared community facilities like community pools, or upon entry/exit from neighboring RBU.

In preferred embodiments, the software functions that operate on the processors 113, 114, 115 associated with cameras 116 and sensors 117 provide visual object recognition capabilities for detecting the presence of persons, vehicles, or other registered types of moving objects within a camera's FOV. Such capabilities are known to those skilled in the art. Object recognition software libraries from companies like NVidia and others are offered to developers for utilization in applications that involve the processing of video streams captured by cameras that are connected to camera processors. For example, the NVidia Jetson processor family, including the Jetson Nano processor, are provided with access to object recognition and labeling functions that support the recognition of persons, vehicles, and other types of objects known by the software, via video cameras connected to these processors operating with these software libraries. Objects for recognition in video streams result from the prior ingestion of image training data sets using machine learning capabilities that accommodate techniques like convolutional neural networks. Using such software and associated processors, persons, vehicles, and other types of known objects can be recognized in a video stream captured in the camera's FOV, and a labeling capability can be employed that provides for the dynamic assignment of a label such as a graphic bounding box, raster mask, or similar that encircles the object or otherwise directly indicates the object (e.g. a simple dot on the object) and tracks the movements of recognized objects. Furthermore, these software functions can be invoked in ways that allow object recognition and labeling to occur only for objects within a delimited region within a cameras FOV, such as used to denote a geofenced region. Objects outside the geofenced region are not subjected to object recognition and labeling, nor will they provide a bounding box around such objects whether they be persons, vehicles, or other known objects in motion. These software and processor capabilities thereby enable the computational assignment of elective privacy protection cloaking capabilities that are applied to visually recognized objects in a cameras FOV. Such software capabilities thus enable an efficient utilization of camera processor resources to focus object recognition and labeling onto just those regions within a cameras FOV that have been selected by the RBU residents or by other authorized users of the CVSS within a community.

In preferred embodiments, the software functions that operate on the processors 113, 114, 115 associated with cameras 116 and sensors 117, can be updated, installed, and deployed for operations via the actions of CVSS system administrators from CVSS data centers 103 across the intervening data networks 110, 111, 112 to those processors. This capability supports efficient centralized CVSS software capability maintenance.

In alternative embodiments, the software functions that operate on the processors 113, 114, 115 associated with cameras 116 and sensors 117, can be updated, installed, and deployed for operations via the actions of authorized community members, or third-parties that they have designated to affect such capabilities, from system administrators or software service providers affiliated with CVSS data centers 103 across the intervening data networks 110, 111, 112 to authorized community members or their designees. This capability supports efficient distributed CVSS software maintenance.

In embodiments, the CVSS utilizes a plurality of digital cameras at 116 that may be attached to individual processing nodes through wireless or wired means at 114. The processing nodes may also have zero or more non-camera based motion detection sensors at 117 that utilize non-video means like audio microphone arrays, LIDAR or radar range finders, microwave radiation, Bluetooth beacon devices, WiFi network signal location mapping, or other non-video means to detect objects in motion, to then transmit signals through the processor node at 115 for the node connected cameras to record or obscure video within the cameras FOV.

In other embodiments, the processor node at 113, 114, 115 supports wired or wireless data communication networking capabilities 112 to communicate data and processing commands via local area networks associated with an RBU. Either the RBU local area network, or a network of multiple camera-processor units, may communicate to a data networking appliance like a router, gateway, or hub, where such appliance is also capable of detecting wireless signals and processing commands from authorized mobile devices running CVSS application software services that support privacy protection capabilities. Mobile wireless data communication devices at 101 supporting such application software and privacy protection capabilities include smartphone or smartwatches equipped to monitor and detect GPS signals that enable the CVSS application software on such devices to detect and transmit GPS coordinates while in the FOV of the CVSS multi-camera per processor units. Mobile devices at 101 and personal computers at 102 are utilized to access, view, or share CVSS recorded video segments that the community member has authorization to do so. Only a community member who has selected to invoke privacy protection capabilities at 101, along with other persons the member has delegated and authorized in advance using personal computers at 102 can access, decrypt, unfilter, view, and share video sequences that observe and record their presence by CVSS cameras and processors.

In still other embodiments, the cameras 116 may be connected to processors that simply act to capture and forward video recordings across intervening data networks for CVSS privacy protection services that are realized at centralized CVSS data centers 103. In such a configuration, the cameras and their processors lack means to detect, label, or denote any humans or objects in motion, and lack means to provide any privacy protection services. As a result, CVSS cloud-based services hosted in CVSS data centers 103, provide all CVSS security, content filtering and content management services, as well as data access control and authorized user privacy protection elections that originate from user mobile devices 101 or personal computers 102.

In embodiments, community members are provided a mobile technical means using their personal devices 101 to electively protect their privacy by effectively enabling or disabling a CVSS camera's ability to capture, record, and transmit privacy cloaked or transparent uncloaked video sequences in which they enter and exit the camera's FOV. Community members, their vehicles, and their pets are likely to be frequently observed within the FOV of cameras 116 nearby their RBU. Community members want to be able to electively control the privacy protection conditions under which nearby CVSS cameras capture and record their movements with or without privacy protection. Community members want to be able to electively enable privacy protection cloaking or to enable uncloaked transparency on demand using 101 devices, or routinely using privacy election choices presented on their registered 101 devices or 102 computers, when the cameras sense their presence or movement within nearby camera's FOV. For example, when residents enter or leave their residence, they may or may not want the CVSS to capture and record such movement, in order to insure the privacy or transparency of their movements. Such choices may be made either on-demand, or made persistent by authorized user elections. In contrast, when other persons, vehicles, or animals not known to them, and not known within the CVSS, approaches close to an entry or exit point for their RBU, or otherwise trespasses without permission onto their RBU property, the residents want the CVSS to capture, record, and possibly report or send notification of such event. Additionally, when persons, vehicles, or animal pets that are known to be community members enter/exit the FOV of a CVSS camera while traversing a public thoroughfare like jogging on a sidewalk, pathway or roadway, driving their car on a street, or walking their dog, these community members can elect to opt-in or opt-out of whether the CVSS cameras they move in front of protects the privacy of such ordinary behavior by cloaking, not recording, or otherwise filtering the visually observable identity of known community members.

### RBU Camera and Processor System Calibration Method

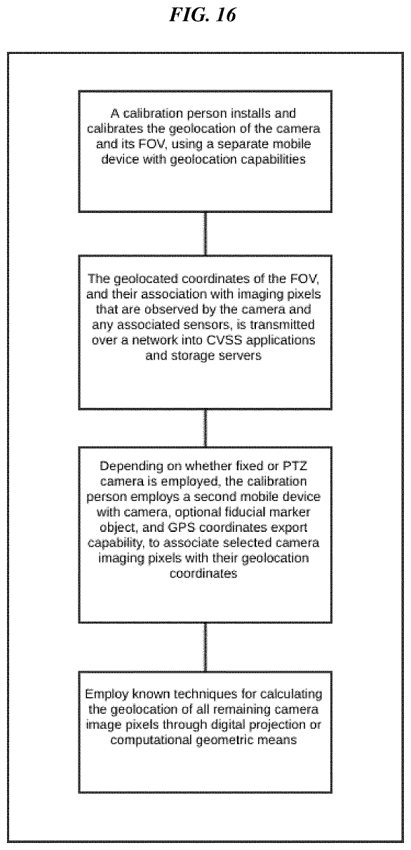

In a preferred embodiment, each camera's FOV at 116 is calibrated such that GPS geolocation coordinates (up to certain distance from the camera) can be converted into image pixel positions apparent in the camera's FOV. This is performed by a calibration system and method shown in FIG. 16. This calibration system includes at least numerous components. One of the components is a user, such as a CVSS camera installation person, equipped with a GPS enabled device positioning themselves at multiple distinct noncollinear points in the FOV of the camera, such as the two most distant image corners and the image's approximate center point, as seen in FIG. 11. This GPS enabled device optionally uses available differential GPS or Real-time Kinematics (RTK) methods, in order to provide highly accurate global geolocation positioning information. The calibration method accommodates, at each point, an image from the camera is captured and the GPS enabled device determines its coordinates. The pixel location of the GPS device in the FOV of the camera is then determined. This can be done manually by a person utilizing the calibration system and method to select the location of the GPS enabled device on the image. Alternatively, it can be done automatically by segmentation techniques known in the art with or without calibration user review and correction. After at least non-collinear 3 positions have determined pixel locations and associated GPS coordinates or GPS area, GPS coordinates for every pixel in the image can be determined by interpolation or similar known technique. This calibration can then be used for every subsequent need to determine if a particular GPS coordinate lies within the FOV of a particular camera.

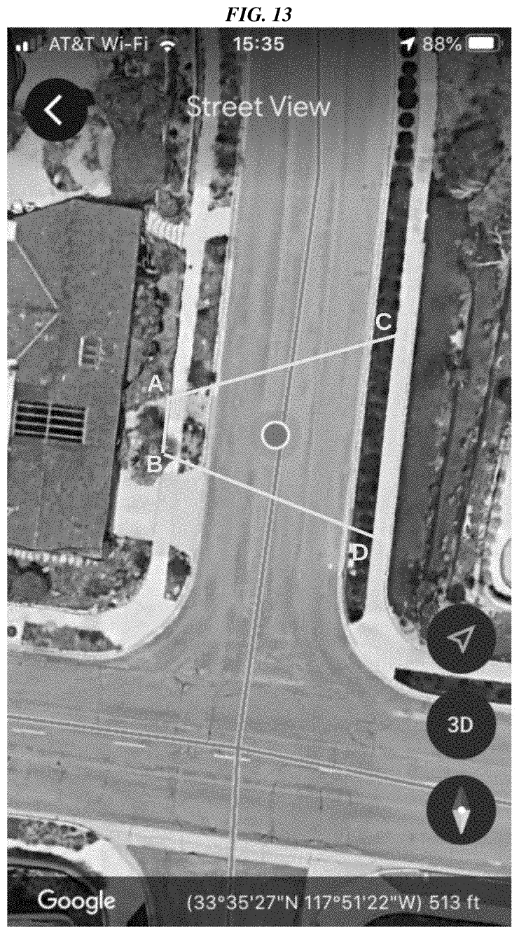

Other non-exclusive methods for calibration embodiment can utilize multiple cameras. For example, the calibration system user can calibrate an RBU camera using a second camera embedded in a mobile device such as a smartphone, augmented reality display or digital geosurveying imaging sensors that can transmit the second camera's GPS location coordinates and video recorded images through wireless network means. A first RBU camera 116 is positioned into fixed location and orientation to establish the camera's field of view associated with an RBU. Video images captured by the first camera's field of view are transmitted by wireless means to a mobile data communications and video display device for observation by a human operator. The GPS location coordinates of the first camera can be determined approximately using the GPS location and transmission of location coordinates using the mobile device equipped with the second camera controlled by the calibration user. The GPS location coordinates of the first camera at 1602 are wirelessly transmitted to a CVSS server or associated camera processor that can perform computational calculations via a networked communication means associated with the mobile device. A calibration user utilizes the second camera in the mobile device to capture a single image that is oriented to include the field of view observable by the first camera. A single image captured by second camera by a calibration user of the approximate field of view of the first camera is computationally combined, utilizing the CVSS server or associated camera processor, with an image from the first camera so that a stereo depth estimation map corresponding to the combined field of view can be calculated. Given the depth estimation map to assign estimated depths for each pixel into segmented regions of the first camera's field of view through geometric calculation means. FIG. 13 provides an example where the depth of field is mapped corresponding to the geofenced region within the FOV of a camera attached to an RBU, as seen in FIG. 11.

Other non-exclusive methods for calibration embodiment can utilize single cameras. Analytical methods known by those skilled in the art can be used to computationally estimate the depth of objects appearing in image sequences associated with a single camera's field of view. Such methods include dynamic depth extraction, geometry-based methods or deep learning methods. Dynamic depth extraction is a capability utilized on Android devices that incorporate two or more cameras, each with a different depth of focus capability, which can be used to computationally extract depth information from the two images captured by the one smartphone device. Geometry-based computational methods include structure from motion or stereo vision matching to determine depth information in the images for system calibration purposes. Deep learning computational methods may employ convolutional neural networks or generalized adversarial networks techniques to estimate depth information in images for system calibration purposes. Alternatively, sensor-based methods that utilize LIDAR sensors combined with camera-based images to determine depth information in the images, when such sensors are available to the calibration system user, such as when embodied in mobile smartphones with multiple built-in cameras and LIDAR sensors that together with software data processing means can computationally determine depth estimates of objects in the field of view of the calibration system camera in real-time.

In alternative embodiments, camera FOV calibration and spatial localization can be performed using other common mobile range, measurement detection, image map projection, or land survey calculation approaches. These approaches can be implemented and deployed during RBU camera installation and setup using the processor associated with an RBU camera. Similarly, these approaches can be employed using other computational services accessed over the CVSS wide area network. Such approaches non-exclusively include alternative means that either: use visual registration apparatuses whose external dimensions are known and then placed in the camera's FOV at or near the center, then employ object measurement by triangulation calculations; utilize geometric and trigonometric calculations that determine which of the camera's pixels in its FOV may be remotely observed on digital street map services like Apple Maps or Google Earth that provide fixed GPS coordinates for an RBU and then add a circumferential radius that intersects the camera's FOV, along with the camera's compass orientation and angular horizontal FOV measure; identify and determine global coordinates that register locations of persistent objects like utility poles, sewer and utility access plates, fire hydrants, curbside mailboxes, etc. appearing in a RBU camera's FOV, then match locations of observed objects with a pre-registered image from an interactive global mapping service like Google Maps using street views that include observation of the same persistent objects, then performing map projection calculations to determine and assign global positioning coordinates to image points or pixels in an RBU camera's FOV; utilize land survey pins commonly positioned around RBUs to denote property boundaries along with the GPS coordinate values that denote an outer trapezoidal boundary within the camera's FOV and then perform geometric and trigonometric calculations to determine a mapping of camera pixel locations with GPS coordinates with an acceptable locational accuracy; use an RBU camera and a second mobile device camera to capture a near-stereo view of the RBU's camera FOV, then used stereographic projection calculations to determine depth of field approximations for image points appearing in both camera's FOV, then calculate mappings of depth of field distances with pixels observed within the RBU camera's FOV, and then compute approximate geolocation coordinates for each observed FOV pixel.

In an alternative embodiment, such cameras and their digital processors at 113 or 114 may utilize other image processing software capabilities, including the ability for an authorized use to establish via pre-registration means geographic regions to demarcate a detectable geofence boundary within a camera's FOV. A camera's FOV can be digitally represented using geofencing means that outline a polygonal boundary region the camera visually observes with its image sensor. Such a boundary can be utilized to signify a separation of public or common community space from private property boundaries of individual RBUs. See FIG. 4. Such a capability is utilized by the CVSS to signify that a person, vehicle, or other object, whether an authorized community member or not, who traverses the geofence boundary from a public or community space to trespass onto the private property of an RBU, to forego their elective privacy protection settings, so that the cameras and processors can capture an unfiltered video stream recording of the trespassing event and persons, vehicles, or other objects observed by the camera.

In an alternative embodiment, individual camera processors 113, or multi cameras processors 114, assign identification label(s) to observable data as meta-data values for moving objects of interest as person, vehicle or other objects, and for non-moving objects like houses with known addresses, parked automobiles, street names, community facility identifiers, etc. The respective camera processors 113 or 114 assigns a composite object identification label to the set of observable identification data and meta-data for static non-moving objects, and for time-varying dynamic moving objects. The processor communicates data records and values across networks 110, 111, 112 to remote content servers 103, which in turn asserts a data value relationship update between static data record attributes and dynamic data object attributes in CVSS database 109. Remote content servers 103 repositories services 107 classify or tag observed moving objects as a collection data type instance that includes identified and labeled data and meta-data values as a person, vehicle, animal, or other object of interest with privacy protection status value (e.g., on or off-default) observable motion behaviors.

In embodiments, at 112 all cameras 116 are installed, positioned, and oriented to observe a geographic region in the community within a camera's FOV. Examples of installed camera locations and orientation of their respective FOV is depicted in FIG. 3 and FIG. 4. The installed position of a camera is fixed relative to their GPS coordinates. When PTZ cameras are employed, these cameras can be directed to change the orientation and scale of their FOV, though their installed position remains fixed in GPS coordinates. At a later date, a camera may be moved to another location, and then again fixed in place. A camera's installed position always has a geolocation, GPS coordinates that persist over time. Similarly, the camera's FOV denotes a limited local geographic region whose center or isocenter also has such coordinates, as does the perimeter of its FOV. Such coordinates are also associated with the nearest RBU street address or community location, in embodiments where cameras are mounted onto a RBU associated with known community members.

In a preferred embodiment, digital cameras 116 come with capabilities for identifying their current geolocation or GPS coordinates. This location information is identified as meta-data that is linked to a video stream recording sequence. Thus cameras are able to identify and add location meta-data annotations while recording, and the location can be associated with the address or addresses of the nearby RBU in a community. Similarly, community members who own or reside in RBU can be associated with the fixed GPS coordinate location of nearby cameras. Additionally, vehicles or animal pets associated with such community members can also be linked to the fixed location of cameras associated with their RBU.

In alternative embodiments, digital cameras 116 that lack capabilities for identifying their current geolocation or GPS coordinates, require the use of a separate technical means or device that can determine the cameras geolocation or GPS coordinates, and that can be used when these cameras are installed and located at an RBU, to establish the cameras locational coordinates.

In an alternative embodiment, individual camera processors 113, or multi cameras processors 114, that are networked by wireless means 112, including WiFi networking, may be equipped with the capability to communicate with, and broadcast a signal to, nearby wireless mobile devices to provide means for determining the mobile devices location. There are at least two ways to determine location with Wi-Fi and/or BlueTooth means. The first one is RSSI (receive a signal strength indication) that refers to data communication readiness signals that can be sensed via 117 from the mobile device with a WiFi geolocation database, like that available from Wigle.net, associated with the processors. RBU communities may also operate such a database that geolocates WiFi or mesh network data communications routing devices within their geographic area. For example, when a mobile device is moving by an RBU with wireless networking that may entail 117, the signal emitted by the network is strongest when the mobile device is close to the wireless networking router, gateway, or transceiver. The other one is used in frequently visited places. It uses profiles of some locations that are on WiFi networks wireless location fingerprinting. It identifies the user's position with 2 meters accuracy. For example, when a person passes sidewalk in proximity to a RBU with networked cameras and processors 113 or 114, wireless network router, gateway, or transceiver can detect the presence of the device, and the device can detect the presence of the network, using network handshake functions.

In embodiments, the calibrated geolocation regions and image coordinates are uploaded via networking means 111, 110 to the CVSS data center 103 for storage 109 and processing within the content networking and processing capabilities at 104 for security and authorization services, 105 for signaling video file capture and storage event meta-data records via 107 at 108 and 109, along with user's current privacy protection election values. The calibrated geofenced FOV of each camera can then be associated with the dynamic geolocation of authorized users and their mobile location signaling devices that carry their privacy protection credentials and elections, as these users move about within their community and are observed within calibrated, geofenced FOV of CVSS cameras.

In embodiments, the geographic locational coordinates of each CVSS camera 116 is to be known and incorporated via 107 into the CVSS data storage repositories 108 and 109, and used by the CVSS software services and end-user software applications 106 in determining which cameras and processor nodes may be temporarily requesting provide privacy protection filtering actions requested and signalled by a smartphone, smartwatch, or other locational coordinates signalling device. The locational coordinates of each CVSS camera can be reported by GPS compatible cameras and processors so equipped, or by other means when the cameras are installed on or near an RBU, for example, by looking up the street address of the RBU nearest the cameras and processors using a third-party networked digital map services like Google Maps, Geocode Finder, or GPS Visualizer.

### Method for Camera Pixel Geolocation Calibration

The calibration method in FIG. 16 covers preferred embodiments at 116 for fixed/stationary cameras and Pan Tilt Zoom (PTZ) cameras whose FOV can be remotely directed or changed to a different FOV. This method is performed by the calibrator, a person or persons who install and calibrate the geolocation of the camera and its FOV. The calibrator uses a separate mobile device with geolocation capabilities, such as one with capabilities of a smartphone like 101. The geolocated coordinates of the FOV, and their association with imaging pixels that are observed by the camera and any associated sensors, is transmitted over a networking means 110, 111 for incorporation into the CVSS applications and storage services data bases 103. This enables the video stream recordings from each camera 116 to support to geolocation-based file and meta-data service transactions performed at 103, that are initiated by users authorized to access, query, or update CVSS managed video recordings and meta-data via 101, 102.

In embodiments using a fixed camera at 116, the calibrator would walk around all over the camera field of view (FOV) while looking at the calibration app on their mobile device. An object detection method like Detectron from Facebook Research, and object tracking method like the motion-based multiple object tracking technique available from Mathworks, would be used to put an indicator of calibrator's positions overlaid on the live video feed from the camera. The calibrator can optionally wear a special calibration fiducial target (on a hat, or an object with a visual calibration and resolution texture, for example) to aid the identification of the calibrator. An infrared emitter can also be used to register a strong signal on the camera imaging sensor. Correlation between the objects' motion vector and inertial measurement unit (IMU) reading on calibrator's mobile device's can be used to eliminate irrelevant motion objects.

The calibrator can also manually correct the geolocation coordinates position observed in the camera FOV by interacting with the mobile calibration app that operates on their mobile device 101 via wireless network means 110.

A number of GPS locations of the mobile device and the corresponding camera pixel locations are then captured and stored. A surface fitting method such as the grid data technique from Mathworks can be used to construct a projection from GPS locations to pixel positions. The calibration app would then inform the calibrator that a sufficient number of points had been captured and the calibration was successful. The calibration app can also request the calibrator to re-start the calibration process if necessary.

In embodiments using a PTZ camera at 116, in addition to the above procedure, the camera will go through PTZ movements and record the PTZ positions along with the pixel coordinates. A higher dimensional version of the data fitting method like Mathworks grid data technique can be used to construct the projection from GPS coordinates to pixel positions across the range of possible PTZ FOV settings.

### CVSS Mobile Devices

In embodiments, the CVSS System 100 can communicate and exchange data with registered GPS compatible mobile devices 101 possessed by authorized users in a community. These devices include commonly available smartphones, smartwatches, and other GPS location tracking devices carried or worn by people, and their animal pets, or borne in the vehicles or moving objects owned, operated, or associated with community residents or their authorized designees. The smartphones include Apple iPhones or Google Pixel phones, phones running the Android operating system, phones running a secure mobile operating system like GrapheneOS or CalyxOS, or other phones or phone-like devices with mobile operating systems compatible with different cellular telephone service providers. These smartphones may utilize common Web browser software or other Internet-compatible application software that utilize common geolocation library software to be able to determine, track, display, and communicate over a network the current GPS coordinates of the device. The devices also include smartwatches like Apple Watch, Fitbit Versa, Garmin Forerunner, Oppo Watch, and other GPS smartwatches from companies like Samsung, LG, and others. These smartwatches may utilize watch-specific Web browser software or other Internet-compatible application software that utilize common geolocation library software to be able to determine, track, display, and communicate over a network the current GPS coordinates of the device. Other GPS location tracking devices including portable tracking devices and locational beacon devices available from many vendors and retailers like Amazon, Best Buy and Walmart. These devices may determine, track, display, and communicate over a network the current GPS location coordinates of the device. However, some such devices have limited or no software applications or hardware capabilities that can display GPS location coordinates broadcast from the device. Vehicles or mobile objects with GPS location tracking devices can determine, track, and display the vehicle or object location, but may have limited or no software applications or capabilities that can report GPS location coordinates of the device over the Internet 110 to the CVSS data centers 103.

In embodiments, the CVSS System 100 can communicate and display video stream recordings using registered mobile devices 101 possessed by authorized users in a community. These users can search, select, and view CVSS video stream files on their mobile devices that have recorded users motion and traversal paths observed by individual CVSS cameras at community locations specified by users, in order to verify whether or not the users elected privacy protection cloaking by viewing the selected filtered video recordings. If users were in motion in their community but did not elect privacy protection cloaking, then the users can only access, search, select and view video recordings that are covered by community choices made for elected privacy protections of community members.

In preferred embodiments, authorized community members utilize their personal smart devices 101 like a smartphone or smartwatch that they carry or wear. Such devices will be running application software that performs numerous functions, including CVSS signalling to/from the smart device, and CVSS video content access and viewing. When an authorized person, vehicle, or other object in motion is detected on a camera system 116 connected to the CVSS, and they have elected to enable privacy protection via 101, the CVSS data center servers 103 sends a notification via 103 to all the camera processor nodes 113, 114 in the CVSS system through network means 110, 111. When the processor nodes receive the notification, it compares the receptive GPS field of the privacy protection notification with the current location (or last location) of the users smart device 101 that posted the privacy protection election signal. If the smart device 101 is within the current FOV of one or more CVSS cameras, or close to within a predetermined proximity distance, the smart device optionally obtains an updated GPS position as well as the estimated positional accuracy (circle of confusion) from its internal position sensors. The smart device then sends its most current position back to the CVSS server through network means 110 along with various device identifying metadata such as user ID, time, software version, device name and version, along with locational coordinates. The data communication exchange and handshake thereby indicates to the CVSS that the cameras nearby, or those cameras whose FOV overlaps the current location of the smart device, should select and filter the video recorded in line with the privacy protection election indicated by the smart device. The smart device may then receive a confirmation message from the CVSS that the nearby cameras did invoke the privacy protection filtering that was elected. As the smart device 101 moves out of the nearby cameras' FOV, as indicated by updates to its locational coordinates that are signalled to the CVSS or local camera processor nodes, then the cameras are instructed by the CVSS via network means 110, 111 to return to their normal, unfiltered video capture and recording modality, while data communication and handshake between the smart signalling device and the previously nearby cameras are ended.

In alternative embodiments, authorized community members utilize a locational coordinates signalling device like a wireless homing beacon device or a GPS location tracking device like an Apple AirTag and Tile Mate that lacks the capability to operate CVSS mobile application software. Use of such devices requires that the network processors associated with CVSS cameras 113, 114, or 115 must operate application software or software services that determines when such a device has signalled its geolocation within the FOV of the cameras. Such signalling devices do not in general provide means for accessing or viewing of video content recorded by the CVSS. Similarly, such a signalling device is unable to allow its user to electively change privacy protection settings, while moving about the community observed by cameras in the CVSS. When a person, vehicle, or known object in motion is detected on a camera system connected to the CVSS, and they have elective privacy protection capability by carrying such a device while moving within their community, the locational coordinates signalling device sends a notification across the network 110, 111 to the CVSS system servers 103, and the system then determines which CVSS cameras are nearest to the location signalling device. If the location signalling device 101 is within the current geofenced FOV of one or more CVSS cameras 116, or close to within a predetermined proximity distance, the smart device 101 optionally obtains an updated GPS position as well as the estimated positional accuracy (circle of confusion) from its internal position sensors. The smart device then sends its most current geolocation position back to the CVSS server along with various device identifying metadata such as user ID, time, software version, device name and version, along with locational coordinates. Detection of the location signal device thereby indicates to the CVSS that the cameras nearby, or those cameras whose FOV overlaps the current location of the device, should select and filter the video recorded in line with the privacy protection election indicated by the device. As the device moves out of the nearby cameras' FOV, as indicated by updates to its locational coordinates that are signalled to the CVSS or local camera processor nodes, then the cameras are instructed by the CVSS to return to their normal, unfiltered video capture and recording modality.

### CVSS Networked Personal Computers

In embodiments, the CVSS System 100 can communicate and exchange data with registered networked personal computers 102 possessed by authorized users in a community. These computers may utilize a contemporary operating systems such as Microsoft Windows, Apple MacOS, Linux, or similar to execute software application programs, network operations, graphic user interface capabilities, and management of files and data storage in main memory, permanent or removable secondary storage units, and other attached processing devices. These personal computers 102 may utilize common Web browser software or other Internet-compatible application software that utilize common geolocation library software associated with geographic maps of different kinds and display formats. These mapping software are able to utilize externally supplied geographic and geolocated data and services, such as the location of retail stores, residential homes, street addresses, and more. Many of these mapping applications are open for integration with remote data services to monitor, track, communicate, and display data stream recordings, such as walking/running pathways traverse by a person or video streams, along with their descriptive meta-data that have been captured, recorded, subjected to elective privacy protection filtering, encrypted, and transmitted over a wide-area network 110. Authorized CVSS system users may therefore search, select, and view video recordings captured by CVSS cameras that may include visual content that has been electively filtered with privacy protection cloaking. These users can search, select, and view CVSS video stream files on their registered networked personal computers that have recorded users motion and traversal paths observed by individual CVSS cameras at community locations specified by users, in order to verify whether or not the users elected privacy protection cloaking by viewing the selected filtered video recordings. If users were in motion in their community but did not elect privacy protection cloaking, then the users can only access, search, select and view video recordings that are covered by community choices made for elected privacy protections of community members.

### CVSS Authorized Users and Other Persons

In embodiments, there are different categories of community members or their designees who may be authorized to access and use the CVSS via 105. Authorizations are associated with event notifications 105, applications and administrative services 106, and video storage repositories access and storage transactions 107, for different kinds of user profiles. The different categories of these users denote different abilities to elect, not elect, unelect, or delegate privacy protection cloaking of CVSS video recordings.

Residents are people who persistently reside in, or occupy as tenants, specified RBUs in a community. Owners are people who own one or more RBUs in a community, but who do not necessarily reside in or occupy any of the community's RBUs. Visitors, employees, and contracted services workers (hereafter visitors) who are invited by RBU residents into their RBU, or into community common areas and facilities, may do so on a temporary, infrequent, or recurring basis. Government and public service employees including police, fire and rescue, and public utility workers are also visitors. Community board of directors are residents or owners of RBUs who oversee the maintenance, operations, security, safety, financial and property management services of common community properties and areas, and who may be authorized by vote of community members to oversee the maintenance, operations, security, and safety of one or more specified RBUs. Community property managers are third-parties engaged by a community board of directors to supervise third-party contracted service providers to oversee the maintenance, operations, security, safety, and financial services for a community. Community members represent the residents, owners, and board of directors associated with a community. Persons who are not in these categories are identified as non-community members. Community members and their visitors can have vehicles, animal pets, or other objects that can be in motion and produce a traversal path within and around a community. Communities can engage third-parties (system administrators) to setup, operate, administer, enhance, and maintain CVSS hardware-based computer resources and servers, software, and networking facilities, systems, application components, and devices, along with data content management services, associated with a CVSS data center deployment located remotely in a cloud, or located locally within a community-based facility. System administrators are engaged as contracted service providers to a community board of directors, to the community property manager, or to their designee.

Communities may designate which authorized community members can act as Neighborhood Watch participants. These participants can receive and send potential community security event notifications to community members. The Neighborhood Watch participants can be authorized by community vote or policy to access and view both unfiltered and filtered video stream recordings have been observed, captured, and transmitted in CVSS video stream recordings. These participants may also be authorized to provide video recording access and potential community security event notifications to third-parties like property management agents or security service providers under contract with a community.

Residents can be authorized users of the CVSS with the ability to elect privacy protection cloaking service using their registered mobile devices 101 any time and any place within their community, as long as such cloaking services does not contradict community elected privacy protection guidelines. Such guidelines may for example, specify the conditions and time periods when community members can access and utilize community common areas, facilities, or properties. Residents can unelect privacy protection cloaking or turn-off their mobile devices at any time and any place within their community, such as when they enter their residence, or another community member's RBU. Residents can be assigned a community privacy protection passport.

A privacy protection passport is a persistent digital means that serves as user authentication credentials for accessing and using the CVSS services and capabilities. A privacy protection visa operates like a privacy protection passport, but differs in that its operational efficacy is limited and temporary. The digital means of such a passport or visa may be realized using access control cryptographic techniques such as hashkeys, cryptographic signatures, user login identifier and password, two-phase user authentication capabilities, wireless remote control signaling device, or similar.

Residents and owners can install and operate one or more networked VSS cameras and processor nodes 112 on exterior of their RBU, or elsewhere within their RBU property boundaries, and may request and receive authorization for such VSS cameras and processor nodes to be registered and integrated with the CVSS compute and service resources 103. Owners are not authorized to override the privacy protections elected by tenants that occupy one of the owners RBUs, without the tenants prior consent, until the tenants occupancy has ended by contract or by legal means. For example, owners who offer RBUs for short-term occupancy like for AirBNB for housing or WeWork for office space, may notify prospective tenants of the CVSS services accessible to short-term occupants, who on agreement, may then be offered specified short-term elective privacy protections while in the community or in designated tenant RBUs. Such capabilities are supported within the administrative services and applications 106 that operate on the content networking system resources 103. Owners can offer tenants occupying the RBU a community privacy protection visa that serve as term-limited user authentication credentials for accessing and using the CVSS services and capabilities.

Community members can request the CVSS to offer visitors visiting an RBU, or common community areas or facilities, community privacy protection visas that serve as term-limited and condition-limited user authentication credentials for accessing and using the CVSS services and capabilities, as long as such cloaking services do not contradict community elected privacy protection guidelines. For example, a community can decide whether or not to offer visitor elective privacy protection visas to government postal delivery employees, or to a package delivery services provider like FedEx, Uber Eats, or Amazon. Such capabilities are supported within the administrative services and applications 106 that operate on the content networking system resources 103.

Community members can collectively vote to determine which elective privacy protection capabilities will be offered to visitors and property managers, and under what terms, conditions, and durations. Such collective decisions can provide blanket visas for elective privacy protections with limited CVSS service access, full access CVSS visas to public safety agencies and personnel, or on-demand visas to specified visitors, among possible configurations determined by a community. Such capabilities are supported within the administrative services and applications 106 that operate on the content networking system resources 103.

### Multi-Mode Methods for Elective Privacy Protection in a CVSS

The CVSS relies on the utilization of a multiplicity of methods to effect and execute elective privacy protection capabilities. These methods effect such means at different component and networking levels portrayed in FIG. 1. Each of these methods is mediated by corresponding security access means that control and limit access to CVSS data content according to user authorization roles and data object schema capabilities.

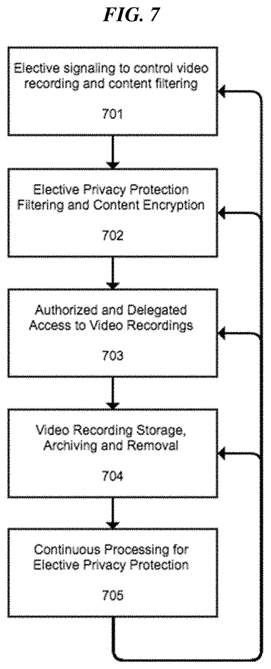

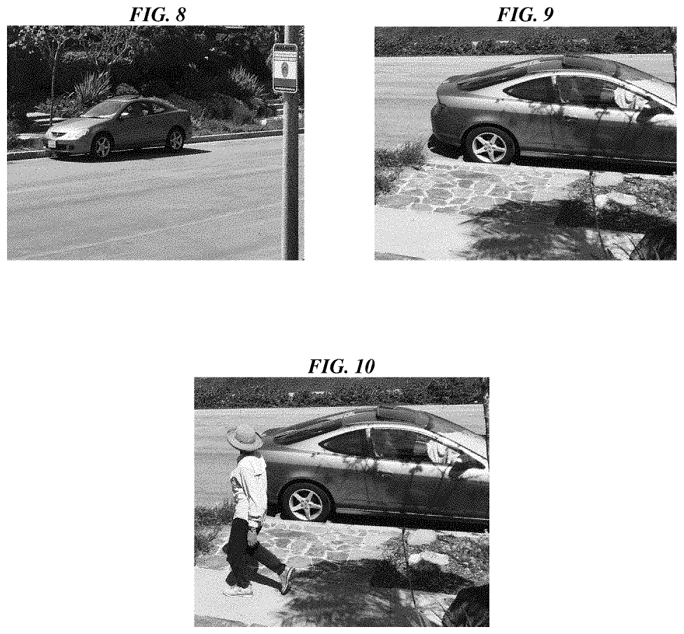

These methods include means for (1) elective signalling to control video recording and content filtering; (2) multi-mode privacy protection filtering and file encryption; (3) authorized and delegated access to privacy protection filtered video recordings; (4) privacy protection filtered and unfiltered video recording archiving and removal; and (5) continuous processing loop with elective privacy protection capabilities. The configuration of method invocation control flow is shown in FIG. 7. Collectively, these methods enable authorized users to access and elect privacy protections, as well as to subsequently access, view, and optionally annotate video recordings captured and managed by the CVSS on an ongoing basis.

### Method for Elective Signaling to Control Video Recording and Content Filtering

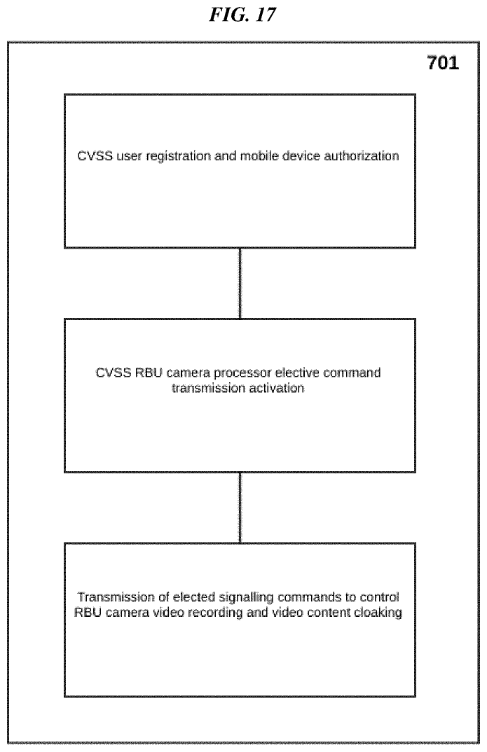

The method for elective signalling within the CVSS to control video recording and content filtering 701 is shown in FIG. 17.

A person, vehicle, or object in motion known in the community carries or bears a CVSS registered and authorized mobile signalling device at 101. This device operates in a local area within community with a CVSS. The device can be used by an authorized community member to electively signal their current preference to opt-in, opt-out, or change current privacy protection settings for video content filtering, while moving within their community observed by the CVSS. The signal is transmitted wirelessly to the nearest video cameras and processor nodes at 112, based on the geolocation of the signalling device determined by the GPS location services associated with the signalling device, and by the geolocation of the nearest RBUs. Cameras and processor nodes based at one or more RBUs may be signalled, if the FOV of the cameras coincides with the location of the GPS location signalling device, whether the signalling device is at rest or in motion. See FIG. 3.

In embodiments, such a device 101 must be registered and associated with a community member, who in turn has also registered by CVSS user sign-up methods with user authorization rights and obligations. This registration and user authorization is required by computational procedures operating as system security services in 104 before any further access or usage of CVSS system functions or capabilities. Records and authorization access are managed via administrative services 106 within the CVSS data center 103. A device that is not registered is not provided with CVSS access or security services capabilities, unless the community elects to designate and determine which CVSS access capabilities shall be provided to community members, to community visitors, or to others who are not signed up as authorized CVSS users.

In a preferred embodiment, such a device 101 is a smartphone with wireless networking and GPS location capabilities in effect.

In an alternative embodiment, such a device is either a smartwatch 101, portable tablet computer 102, GPS position location device, a location-aware wireless network transceiver, or vehicle-based position location device, with wireless networking and GPS location capabilities that can engage data communications with either the CVSS content networking servers 103, a wide-area network 110, a community-area network 111, or with nearby camera processors 113, 114, or 115.

In embodiments, the transmission of signalling commands is realized using a wide-area data communication service 110, such as a cellphone service, the Internet, or a community-wide network 111 using other wireless data networking service that is open for data transmissions to/from nearby mobile signalling devices.

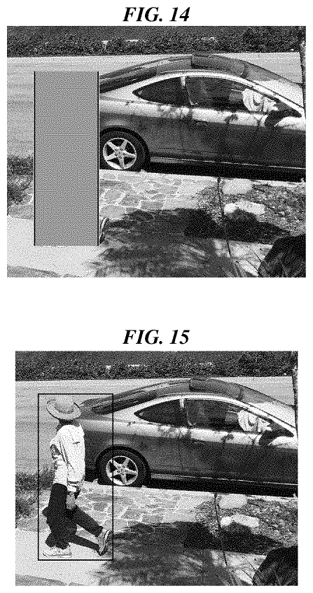

In a preferred embodiment, signalling may effectively command nearby video cameras and processor nodes 113, 114, or 115 to visually cloak the content of a motion detection bounding box that surrounds an authorized person, vehicle, or objects known in the community, whose visually detected motion triggers recording and potential upload of the video stream recording that includes the detected motion content. This is shown in FIG. 14 and FIG. 15.

In an alternative embodiment, signalling may effect a short duration “pause in video stream recording” at the associated camera processor nodes 113, 114, 115, much like the pause button on a video recorder remote control, thus bypassing the need for complex image processing-based filtering to obscure, redact, or erase visual content in real-time. This alternative provides complete momentary privacy protection since no video is recorded or transmitted across networks to the CVSS servers.

In an alternative embodiment, signalling may effect a short duration network transmission signal jamming or stoppage means at the associated camera processor nodes 113, 114, 115, much like the stop button on a video recorder remote control, thus bypassing the need for network communication of filtered or visually obscured video content to CVSS servers at 103.

### Methods for Community Members to Elect Privacy Protection Filtering, Video Recording and Data Encryption

There are multi-mode means that the CVSS utilizes to support privacy protection elections by different community members via selection in 702 of one or more of the following privacy protection modes.

In a preferred embodiment, Community residents (persons, vehicles, pets) with a mobile signalling device operating CVSS application software and privacy protection passport at 101 can electively request (opt-out, opt-in, or change) privacy protection settings that filter (obscure, block, or cloak) persons, vehicles, and their associated objects captured in video stream recording and network transmission while moving within their community. Such signalling device at 101 requires wireless data communication means to transmit such a signal to the CVSS servers at 103. These servers then communicate with cameras and processor nodes nearby the current location of the device to follow the privacy protection settings elected by the community residents at that location.

In alternative embodiments, community residents with privacy protection elected via their mobile signalling device 101 may not be able to have their video stream recordings filtered and protected, if these residents trespass into another resident's RBU private property area where they do not reside. Similarly, residents who have entered into a common area they are not authorized to access at any time, or at community elected time periods (when facilities are indicated to be closed), are denied privacy protection, if the RBU cameras are configured with an RBU's geofencing settings that demarcate property trespass areas, and that detect and video record motion activities occurring within the geofenced trespass areas associated with elected time access constraints. Such trespass zones can be indicated and associated with geofenced regions within a cameras FOV 116.

In a preferred embodiment, the CVSS determines if person, vehicle, or moving object observed within RBU camera's FOV 116 is transmitting a CVSS registered user identification beacon or similar wireless smart device signaling means 101 that indicates GPS coordinates available, and privacy protection capability. If the privacy protection election indicated is opt-out or not available, the RBU cameras 117 record and transmit video stream from camera processor node 113 across networks 110, 111, 112 to content server 103 with video stream files stored in CVSS video file servers 108, and video stream meta-data to be updated and stored via 107 into CVSS database 109. If the privacy protection election indicated is opt-in, the person, vehicle, or moving object is authorized to receive CVSS privacy protection services through their activation of signaling means, then the CVSS applies privacy protection cloaking means to digitally filter and encrypt, captured and recorded video stream sequence.

In embodiments, CVSS processing capabilities for video cloaking filtering are established as either decentralized or centralized operational configurations. In a decentralized CVSS processing configuration, cloaking occurs through software controlled means at the processor associated with a RBU camera 113, 114, 115 prior to encryption and data transfer across a wide-area network 110, 111 to the 103 content networking processing resources. In a centralized CVSS processing configuration, video cloaking filtering occurs at the CVSS data centers 103 through computation and applications 106, after the video files have been encrypted and transferred across connected networks 110, 111. The CVSS continues to track, monitor, record, upload, and report filtered and encrypted continuous video stream captured from video cameras 116. Community members or their visitors who are authorized persons, or moving within their community in vehicles, and other authorized moving objects like member pets, are automatically privacy cloaked or re-cloaked as they continue to moving within the FOV of a sequence of adjacent video camera sensors within an overall video surveillance system network, as shown in FIG. 14. The privacy protection request endures until disabled, such as when the elected time access period expires, the authorized user signals end of privacy protection request, the user enters the RBU where they reside to signal end of request, or the user leaves the community perimeter thus dropping detection of the request activation.

In preferred embodiments with decentralized CVSS processing capabilities, video stream recording (file) encryption for file transmission across wide-area networks occurs after elected privacy cloaking/filtering methods have applied by the camera processors 113, 114, 115. Additionally, user data associated with video file protection and subsequent access, is effected using ways and means that secure file and associated user data transmission across CVSS networks via a multi-level encryption security scheme. This scheme utilizes a multiplicity of security techniques that include key-based encryption, secure data delivery protocols, user and video content access control passwords, virtual private network access restrictions, and data center specific data communication encryption means, as follows. First, key-based multi-bit encryption methods (ways) such as AES-256 that utilize secure, long multi-bit digital keys to rapidly encrypt file contents. Key-based encryption applied to captured and recorded video recording streams at the camera-processor nodes. This encrypts the recorded video stream files at the camera processor node 113, 114, 115 prior to transmission over a network separate from any extant RBU network 112, such as a community data communications network 111, or a wide-area network 110. Second, using secure HyperText Transfer Protocol (HTTPS) delivery from the camera processor nodes 113, 114, 115 over a wide-area network means 110 to encrypt meta-data descriptors associated with the recorded video stream files, along with the network source and destination locations. Third, each CVSS authorized User or RBU provided password-protected Video recordings are subject to local user authentication ways associated with capabilities at 104. This provides designated users the corresponding access control key needed to retrieve and decrypt (or unlock) the AES-256 encrypted video stream recordings for playback and viewing on the user's mobile or desktop computing device in conjunction with security administration services at 106. Fourth, Community elected geographic location and virtual private network restrictions provide means to require the CVSS to maintain meta-data at 109 associated with users, user mobile devices, and personal computers, in order to access the CVSS over encrypted virtual private network connections. This provides or denies designated authorized users the ability access filtered and encrypted video streams based on their physical or networked address location associated with a community's CVSS. Fifth, using Secure Video Datacenters and Content Delivery Networks means 103, Cloud-based data centers and CDN like those hosted by Amazon Web Services, Google, Microsoft Azure, or others provide internal user and content identifiers associated with role-based access-control lists at 104,106 that specify which authorized users can access and view what recorded video stream files, on which registered user devices 101, 102, and in which data streaming format to utilize to transmit and display the selected files to the registered and authorized user.

In a preferred embodiment, Residents of an RBU can electively access unprotected and unfiltered CVSS videos recorded from cameras 116 and processor nodes 113, 114, 115 for networks 112 connected to their RBU. An RBU resident can access and view unprotected video recordings based on VSS cameras associated with their RBU.

In alternative embodiments, an RBU can contract with a third-party to remotely access and view unprotected video recordings as an authorized user that are captured by cameras 116 connected with their RBU. In these embodiments, delegation of video recording access may be prioritized to first provide access and event notifications to Neighborhood Watchers, and to second provide access and event notification to third-parties like property management agents or security service providers under contract with a community, if there are no Neighborhood Watchers currently active and monitoring community security.

In a preferred embodiment, Community members can delegate virtual Neighborhood Watch participants access to specific community members (e.g., adjacent neighbors or people designated to temporarily act as Neighborhood Watchers) or to third-parties who can then view, report, and share unprotected videos of non-protected persons, vehicles, or pets moving within the community.

In a preferred embodiment, Communities that are adjacent to other communities, each with a CVSS (see FIG. 5 and FIG. 6), can elect to share data and security event notifications across shared community boundaries, or across shared open/public spaces between community boundaries, via wide-area networked data communications means.

In FIG. 6 when denoting two communities, this creates potential conflict in privacy protections for members of one community who traverse open space in-between inter-community boundaries. In non-exclusive alternative embodiments, adjacent communities each with a CVSS, can utilize wide-area networked data communications means 110 to elect to share data and security event notifications that span community boundaries with third-parties who are contracted by the adjacent communities to access and monitor security event notifications that span shared community boundaries or open spaces in between these adjacent communities.

In a preferred embodiment, conflicts arising when different community's CVSS detect authorized users with privacy protection passports are resolved through multi-community affiliations or networks that offer individual community members an application capability to request and be authorized to receive a privacy protection visa for the specified adjacent community. These capabilities enable authorized residents of one community's CVSS to keep their elected privacy protections in effect across other community's CVSS, except to when the residents enter another community that has collectively elected to either not honor such passports, or that community revokes or constrains certain privacy protections for visitors who are currently authorized passport holders from another community. For example, as depicted in FIG. 6, a community member with a privacy protection passport from the left-side community, may traverse the public space in between, so as to enter the realm of the CVSS of the right-side community. This person from the left-side community in FIG. 6 may further traverse into the right-side community into that community's common area, where the right-side community members have collectively elected to denote non-right-side community members as visitors, who may request and be granted/denied a visitor privacy protection visa.

In alternative embodiments, Communities that are members of a larger multi-community enterprise or industry association can be electively and securely 104 authorized by individual communities to access and share via 106 anonym ized and privacy protected video files 108 and CVSS security meta-data 109 with other communities, via wide-area networks 110 that are associated with, and interconnect, these enterprises or industry associations.

### Method for Authorized and Delegated User Access to Video Recordings

In 703, authorized and delegated access to video stream recordings includes functional capabilities for video search, retrieval, decryption, filtered or unfiltered viewing, and sharing with others via delegation.

In preferred embodiments, authorized users are issued digital access credentials at 1901. These credentials are meta-data records suitable for storage and processing at 109. These credentials are specified as privacy protection passports (PPP) for community members. These passports are issued and accessed via secured authorized user authentication means through 101, 102, that are mediated by 104, 106, 108, 109. These passports may persist for long duration periods with the greatest level of elective privacy protection capabilities. User access credentials for persons designated as visitors, property managers, and system administrators, are specified as privacy protection visas (PPV) accessed and mediated like passports. These visas are specified as temporary and may stipulate specific temporal, physical community, and RBU region limits on elective privacy protections and other constraints as to what kinds of user access and transactions may be conducted with a visa. Authorized users may request visa credentials to be issued for their visitors and their mobile devices 101 at 1902, upon providing visitor user profile meta-data for storage in 108, but subject to the limits, constraints, and other guidelines established by the Community that are handled at 106.

In alternative embodiments, access authorization or delegation is managed at 1903 by Role-based access control capability lists (ACCLs) for different categories of CVSS users (i.e., user roles) at 103, 104, 106, and their respective mobile devices 101, and personal computers 102. Use of ACCLs is extended to include those associated with the persons' vehicles and objects in motion for privacy protection (animal pets, assistive mobile robots, etc.). A non exhaustive set of roles to be accommodated includes: (a) Residents who persistently occupy particular RBUs in their community; (b) RBU Owners, who may or may not persistently occupy the RBUs they own; (c) Community Board of Directors; (d) Community and RBU Visitors; (e) Community Property Managers; and (f) CVSS System Administrators. ACCLs that delegate access to CVSS content are subject to elected privacy protection assignments at 1904 made by community members to other members, as well as to visitors, property managers, system admins, are subject to collective community elected privacy protection guidelines, setup to operate at 103 via 104, 106, 108 through access means at 101, 102. This access capability is enacted as users and visitors move throughout a community, and their geolocation can be determined, while carrying their CVSS registered mobile devices 101 equipped with CVSS geolocation signaling means.

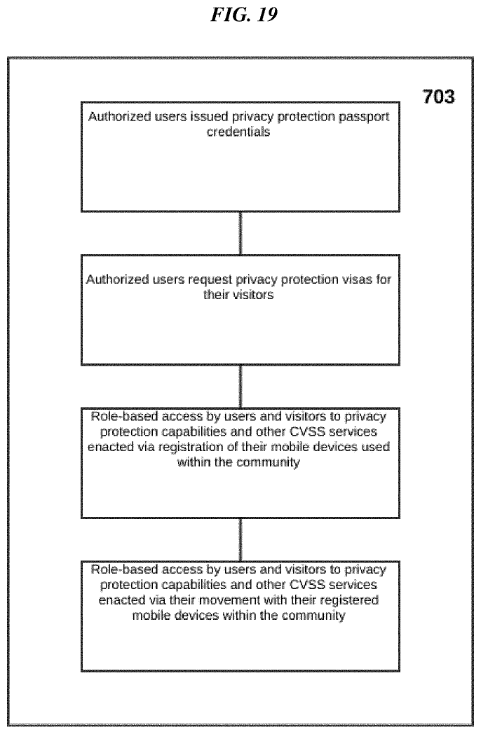

FIG. 19 illustrates one embodiment of a Structure and Flow for Authorized and Delegated User Access to Video Recordings Method.

### Method for CVSS Video Recording Archiving and Removal

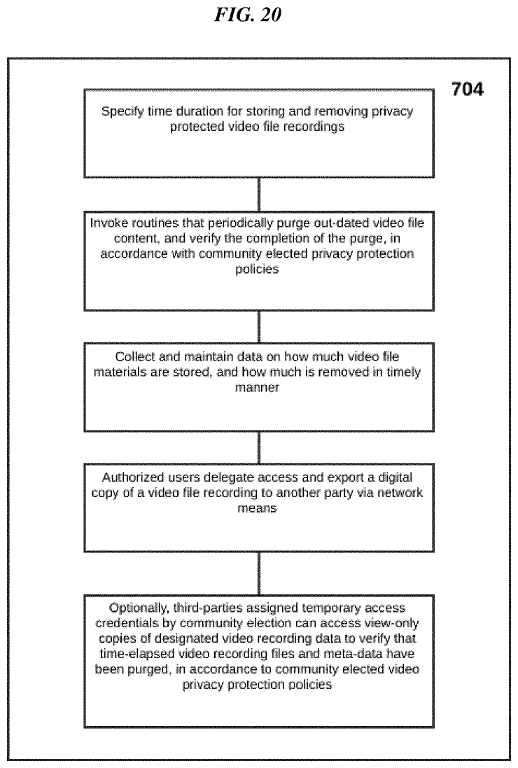

This method identifies functional capabilities and processing flow as depicted in FIG. 20 for archiving and removal of video materials captured with or without elective privacy protections in effect, at 704.

In a preferred embodiment, privacy protected CVSS video stream recordings stored within file servers 108, which represent video data files, and their descriptive meta-data stored within database server 109, do not persist without time limits. Privacy protections associated with these video recordings and their associated meta-data, may or may not persist without time limits. Community members collectively decide and elect across their community how long video recordings should be stored for retrieval and update, else marked for deletion and then permanently removed from storage. An expunged video file can no longer be accessed, retrieved, viewed, shared, or otherwise updated--it no longer exists. Default file storage duration may be set to 28 days, but can be reduced to as little as one day or increased up to 365 days, depending on the archiving limitations determined by the community via collective privacy protection election.

In a preferred embodiment, CVSS video data repositories 108 and 109 based in CVSS data centers 103 will be routinely and verifiably purged of dated video file content in accordance with community-wide privacy protection policies they have elected. Such video data purging may be enabled through computational applications and administrative services 106 operating within the CVSS data centers 103 by CVSS system administrators employed by the community.

In a preferred embodiment, CVSS content purging application services at 106 are utilized to maintain the relevance and timeliness of file storage, as well as reducing and avoiding the costs associated with maintaining continuously growing video stream storage. Community members collectively elect the time duration or other video recording access control guidelines of files being stored. System administrators take this information and utilize it to configure procedures for video content removal via their networked personal computers 102, where such procedures when executed create a log that includes minimal file meta-data descriptors associated with files removed, and associated digital fingerprints or blockchain transactions that can be utilized to independently verify that the identified video files were removed, and cannot be reconstructed or retrieved henceforth.

In preferred embodiments, an authorized CVSS user can delegate access and export a digital copy of a video stream file via 101, 102 to another person, application services providers, or other third-party. Such a file copy may capture and observe that person, their vehicle, or their animal pet being recorded while carrying or bearing a privacy protection signalling device associated with that community member. Video files once delegated for copy and then exported to others, reside outside of the CVSS. These exported video files may endure indefinitely, and may no longer provide elective privacy protection capabilities, as the files are beyond the scope of the CVSS.

In alternative embodiments, a community can contract with a remote third-party who is provided with temporary security access credentials that allows them read-only or view-only access via 104 to designated video recording data 108 and 109, to verify that time-elapsed video recording files and associated descriptive meta-data have been purged in accordance with community-wide privacy protection policies that have been elected.

### Method for Continuous Processing Control Loop for Alternative Configurations Supporting Elective Privacy Protection Filtering

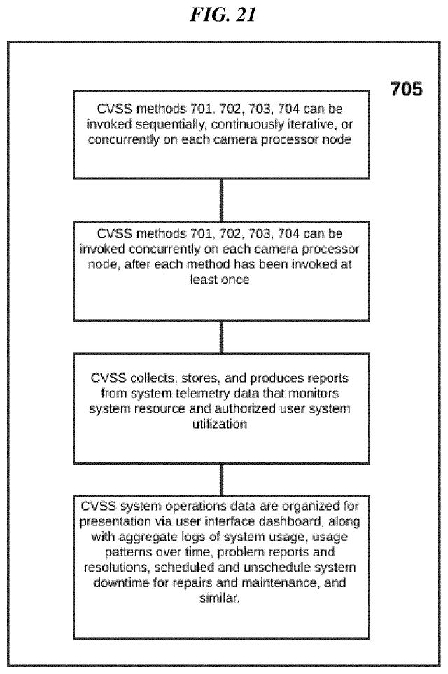

This method denote the overall continuous processing functionality for elective privacy protections capabilities starting at 705 and then allows further processing actions at either 701, 702, 703, 704. FIG. 21 depicts the structure and flow of functional capabilities that enable this continuous process control loop for CVSS services deployed in either decentralized or centralized configurations.

In embodiments, the CVSS methods indicated above can be invoked in either a sequential, continuously iterative, or concurrent manner, across each sensing camera-processor node in the CVSS network based on detection of new sensing unit inputs that correspond to persons, vehicles, animals, or other moving objects that have not been previously recognized, labeled, tagged, or privacy cloaked.

In a preferred embodiment, all CVSS methods can be involved concurrently based on demand, once each method has been initialized and executed at least one time.

In a preferred embodiment, The CVSS needs to incorporate a systems operation telemetry data capability that continuously monitors overall system operation, maintains logs and reports on CVSS network, subsystem, or device uptime, downtime, or unit failures. This telemetry data is monitored and utilized by CVSS system administrators to operate and improve the operational capabilities of the CVSS systems and components specified in FIG. 1.

In a preferred embodiment, The CVSS system operations data are organized and reported via a CVSS operations user interface dashboard, that is supplemented by persistent logs of overall system usage, usage data patterns over time, problems reported, problem tracking and resolution, scheduled and unscheduled downtime for system repairs and maintenance, and the like. In addition, data pertaining to videos recordings made with and without privacy protection filtering may be displayed, as may data accesses and video viewing by Neighborhood Watch participants, as well as accesses and views by participants residing in other affiliated with other communities operating their own CVSS.

In a preferred embodiment, the CVSS having received position information from each smart device will then determine if any of the smart devices represent the object of interest moving within the current FOV from the camera of interest.

### Method for Structuring and Processing of Elective Privacy Protection Passport and Visa Credentials

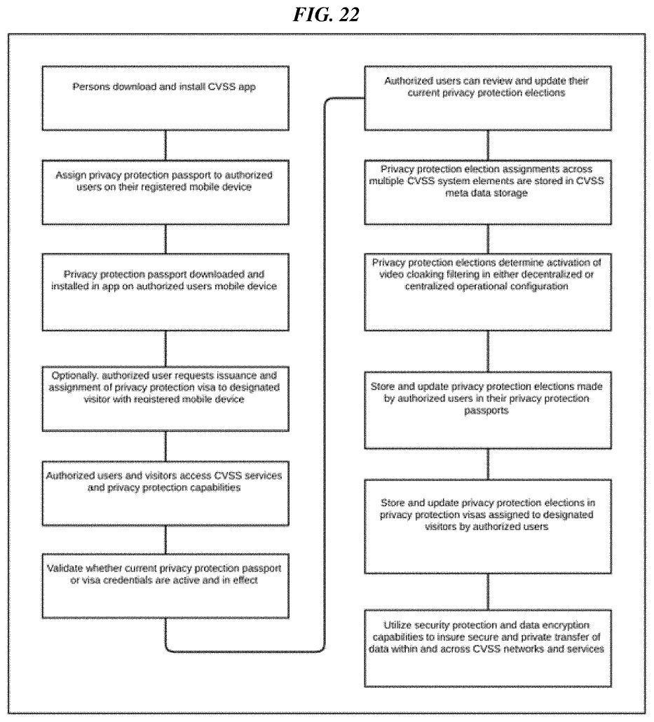

The method depicted in FIG. 22 denotes a non-exclusive embodiment of ways and means for the structuring and processing of elective privacy protection capabilities through digital user credentials identified as privacy protection passport (PPP) or privacy protection visa (PPV). The passport are persistent digital credentials for authorized users who are identified as permanent or long-term residents of a community. The visa are temporary digital credentials for other users who are designated by community members who may be visitors, property managers, system administrators, or other delegates. Passport enable the fullest set of elective privacy protections and video material access and transactions, whereas visa enable a subset of these privacy protections, access, and transactions. A digital copy of the passport is carried within a mobile device, moving vehicle, or movable object operated by an authorized user using 101. A digital copy of a visa is carried within a mobile device operated by a designated visitor, or else on a networked personal computer 102 for other designated parties. Digital copies of passport and visa credentials are also created, stored, and deployed through network means 110 to authorized users and other designated parties from application and administrative servers 106 operating in the CVSS data center 103.

In embodiments, 101 mobile devices carried by CVSS authorized users, vehicles, or other registered objects must incorporate digitally processed means for including privacy protection credentials that can be electively activated (opt-in) and deactivated (opt-out) when within the purview of the CVSS. Such credentials are utilized to invoke and transmit privacy protection election signals across CVSS networks to all relevant camera CVSS camera processors or CVSS data center servers. The credentials themselves are not transmitted to RBU camera processors. The credentials are setup and utilized when community members are matriculated as authorized CVSS users. The credentials are stored in a CVSS data store via 106 that is distinct from the repositories used to store and retrieve CVSS meta-data 109 or video file servers 108.

In preferred embodiments, all accesses and update transactions to privacy protection passport or visa repositories are cryptographically encrypted and stored via 104 using service means such as blockchains or other common data transaction ledgers, in ways that accommodate unknown third-party validation techniques.

In alternative embodiments, all accesses and update transactions to privacy protection passport or visa repositories are recorded and stored via 104 using any feasible, secure user account record keeping computational means compatible with extant secured user authorization and access services at 104.

In alternative embodiments, 101 mobile devices carried by CVSS authorized users, vehicles, or other registered objects, incorporate digitally processed means for including privacy protection credentials that can be manually or automatically deactivated on exit from areas designated as outside the CVSS purview (e.g., when leaving the community or traversing beyond community boundaries, or when entering a RBU residence within the community).

In embodiments, a privacy protection passport or visa is a digitally encrypted means that incorporates a record of descriptive data or meta-data associated with a CVSS authorized users, or their associated vehicles and movable objects. For example, a CVSS passport or visa preferably includes a computationally generated via 106, cryptographic digital identification key stored in 101, that can include a digital signature, and where the key and signature are computationally resistant to tamper, duplication, and unauthorized decryption.

n embodiments, privacy protection passports are intended to operate persistently and for long term duration for authorized community members, while visas are intended to operate ephemerally for short term duration for visitors and other designees associated with community members. Passports and visas can be electively assigned and revoked by communities following policies established by the community, and openly communicated to community members. The community that operates a CVSS determines what personal data is required for inclusion in the passport or visa, such as identification of RBU address associated with users who are authorized as residents of the RBU, and other community specified descriptors such as vehicle parking space assignments, animal pets who are allowed to move within the community, members or visitors authorized to access community common areas or facilities, access gates or doors to community areas, authorization and expiration dates, whether community members are enabled to authorize visas for their visitors, and the like. Such data is entered and uploaded by community members or their designees using 102. The passport and visa incorporate time of day for entry and exit transactions within the community's CVSS purview. The passport and visa do not store data associated with traversal paths or identify specific places within the community engaged by authorized users, vehicles, or registered movable objects.

In preferred embodiments, communities can elect for their CVSS to collect and store transactional and movement traversal information as video meta-data using 109, and also video recordings using 108, of non-authorized persons, vehicles, and movable objects that enter and exit the purview of their CVSS. Communities can further elect for their CVSS to collect and store transactional and movement traversal meta-data, and also video recordings, of visa assigned persons, vehicles, and movable objects that enter and exit the purview of the CVSS.

In alternative embodiments, multiple communities operating their respective CVSS's can electively engage to encrypted sharing of CVSS privacy passport capabilities for authorized members and vehicles of at least one of the communities, that operate in a similar manner to visa privacy protection capabilities across all participating communities. Such sharing requires enablement and configuration of remote user access and elective privacy protection visa authorization services via 103 that is communicated across wide-area networks 110 from one CVSS data center to another, also operating via 103.

In preferred embodiments, the means for structuring the processing and flow of privacy protection passports and visas should incorporate the following capabilities.
1. Persons, such as authorized users and visitors, download and install CVSS mobile software application for operation on their registered smart phone, smart watch or similarly capable mobile device 101
2. Privacy passport assigned to authorized users including their CVSS digital user profile, registered mobile devices, and associated digital identifiers meta-data via action affected at content networking data services 103
3. Passport downloaded and installed in CVSS app on authorized users mobile device 101
4. Authorized user can request privacy visa assignment via their registered mobile device 101 or networked personal computer 102 to visitor's mobile device 101, after visitor has installed CVSS mobile device app, and requests privacy visa from authorized user
   a. Visa downloaded and installed in CVSS app on authorized visitors mobile device 101
5. Authorized users and visitors establish access to CVSS via means that may include user authentication challenge such as entry/re-entry of current password, two-factor authentication, user biometric account data on device, or similar via their registered mobile devices 101 or networked personal computer 102.
6. Utilization of passport/visa on mobile device within CVSS depends on online validation of user/visitor possessing a currently active passport/visa status using their registered mobile devices 101 or networked personal computer 102.
7. With active access and valid passport, authorized users can review and update their privacy protection elections currently in effect using their registered mobile devices 101 or networked personal computer 102.
8. Privacy protection elections associated with user profiles, registered mobile devices, RBU residencies, RBU residence networks, RBU network processor storage capabilities, individual video stream recordings and associated meta-data for time and geolocation, community privacy policies and constraints, Neighborhood Watch delegations, assigned third-party content access and review capabilities, and cross-community visitor visa access and utilization capabilities at member communities within neighboring communities and multi-community associations, all of which are stored and updated in CVSS meta-data databases 109 via application services at 106, 107.
9. Privacy protection elections affect the application of video stream content cloaking and uncloaking filtering actions at camera processor nodes 113, 114, 115 in decentralized configuration, or in centralized application services affected at 103, in line with the privacy protection elections an authorized user, visitor, or third-party have made and are currently in effect.
10. Privacy elections for authorized users passports are associated with their user profiles, registered mobile devices, RBU residency, RBU residence networks, RBU network processor storage capabilities, individual video stream recordings and associated meta-data for time and geolocation, community privacy policies and constraints, Neighborhood Watch delegations, assigned third-party content access and review capabilities if any, and cross-community visitor visa access and utilization capabilities at member communities within neighboring communities and multi-community associations, all of which are stored and updated in CVSS meta-data databases 109 via application services at 106, 107.
11. Privacy elections for visitors with active visas are associated with their user profiles, registered mobile devices, authorized user RBU residency, community privacy policies and constraints, assigned third-party content access and review capabilities if any, and cross-community visitor visa access and utilization capabilities at member communities within neighboring communities and multi-community associations, all of which are stored and updated in CVSS meta-data databases 109 via application services at 106, 107.
12. Privacy elections made by authorized users or their visitors on registered mobile devices 101 and networked personal computers 102 may be protected by security protection capabilities that include persistent passwords, one-time use passwords, two-factor authentication, multi-factor authentications, biometric authentication, geolocation authentication and validation, and the like as well as via data encryption and decryption mechanisms applied on user mobile devices 101 or desktop personal computers 102 to before and after network transfer of individual video stream file recordings and associated meta-data via content networking resources 103, data encryption mechanisms applied to video stream file recordings and associated meta-data at camera processors 113, 114, 115 prior to their network transfer, and network transfer of video stream files and meta-data across wide-area data communication networks 110, 111, as well as data networks within content networking data centers 103.

### Privacy Protection Policy Capabilities

Platforms, systems, and methods described herein can have privacy protection policy capabilities, such as policy-based privacy protection capabilities in a CVSS. Policies and constraints (hereinafter “policies”) are expressed as computational mechanisms that determine the applicability of different system processing rules in different application situations. Policies affect governance, oversight, protection, authorization, control, and delegation of rights, privileges, and obligations for system users. Policies are elective, and are expressed in human understandable forms for voting, communication, and for practical action in a community. Policies are determined, revised, or revoked by an elective vote. In CVSS, privacy protection policies are determined by an elective vote of homeowners, residents, or other authorized persons for rules that regulate video security and privacy protection system behaviors. Such policies can be coded to non-exclusively reside and operate within the CVSS data center 103, the data repositories 108, 109, the computational applications and administrative services 106, 107, in authorized user privacy protection passports or visas, the camera processors 113, 114, 115, the mobile devices 101, and the personal computers 102 that support authorized user access to CVSS.

Another example of privacy protection policy capabilities is predictive re-identification of persons, vehicles, and animals without individual privacy cloaking capabilities within a CVSS. Policies can be formulated to enable the predictive re-identification of persons, vehicles, and animals who lack privacy protection, as determined through actions shown in FIG. 7, as such entities in motion move across the FOV of a sequence of adjacent or near-adjacent VSS cameras 113, 114, 115, as they might be deployed and installed, as indicated in FIGS. 3, 4, 5, and 6.

Another example of privacy protection policy capabilities is systems and methods for delegating authorized access via privacy policy profiles. Such systems and methods simplify and streamline recurring delegation of privacy protection authorizations for access and use by RBU owners, resident tenants, non-resident visitors, and others are needed. Alternative but non-exclusive embodiments to those already indicated in FIGS. 7 and 22 can utilize (a) reusable and customizable policy profiles for privacy protection passports, (b) pre-determined and fixed policy profiles for visitor privacy protection visas, (c) generic single use visitor profile privacy protection visas, (d) means for automatically updating privacy protection passports for authorized community residents as the result of an elective vote by RBU owners.

Another example of privacy protection policy capabilities is integrating residential interior and exterior perimeter video security within a CVSS. Many RBU owners, residents, and tenants have pre-existing, legacy VSS installed and operational. These VSS lack the capabilities and privacy protections of the CVSS already identified. As such, there is practical need to provide embodiments of CVSS system elements that can be integrated with these legacy VSS. In alternative but non-exclusive embodiments, the embodied means for integrating legacy VSS cameras with data centers 103 can be provided through the incorporation of either (a) a mechanism that allows for the bypass and passthrough of VSS video streams to RBU premises-based VSS recorder, (b) the addition of a wide-area networked connected processor similar to those indicated for 110, 112, 113, 114, 115, (c) a digital interface such as an application program interface (API) to a non-CVSS remote VSS network services provider that allows for sharing video content streams captured and uploaded across a wide-area network 110 to a data center 103, (d) a digital interface (API) to a remote VSS data center that supports access and download to video stream recordings by authorized users via a mobile device 101 or networked personal computer 102, and (e) a configuration of elements in (a)-(d) that best matches and simplifies that integration of the legacy VSS with CVSS platforms, systems, and methods.

### 3D Community Mapping Capabilities

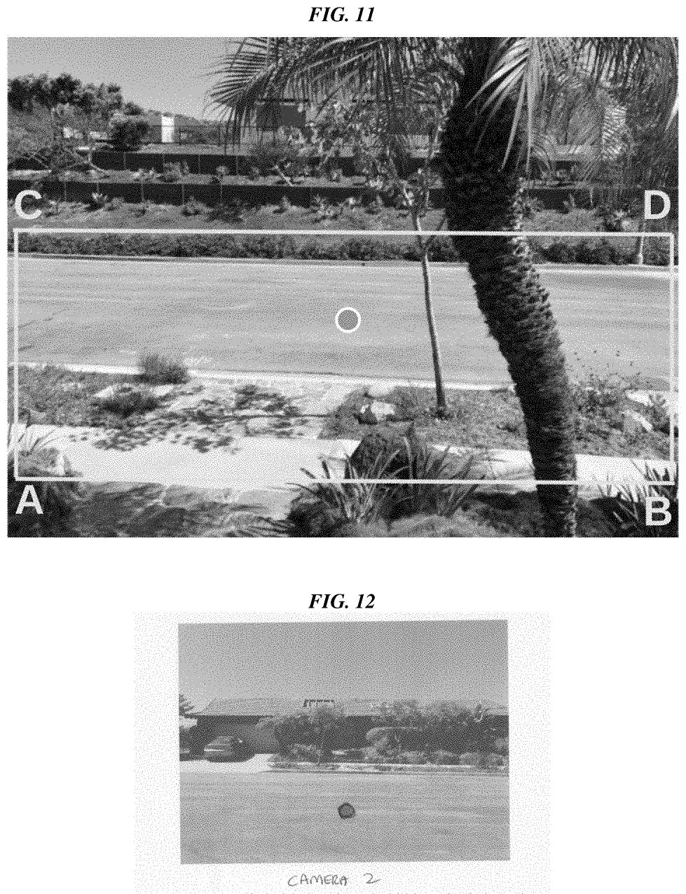

Platforms, systems, and methods described herein can have 3D community mapping capabilities, such as digital elevation and terrain mapping as a basis for CVSS. In some embodiments, there is practical need to use mobile photogrammetry devices and techniques to create 3D maps of a community observed by networked cameras 113, 114, 115. 3D maps are needed to locate individual RBUs, as well as pathways, sidewalks, and roadways that connect or are adjacent to RBUs. Limited 2D versions of such maps are shown in FIGS. 3, 4, 5, and 6. Other persisting objects, including but not limited to trees, plantings, gardens, fountains, statuary, and architectural monuments, also need to be located and their volume estimated. Objects such as these can cast shadows and moving shadows under different illumination, weather, and lighting conditions, and they can also be utilized by perpetrators as temporary hiding places that occlude the FOV of networked cameras. 3D digital maps can be superior to 2D maps in that they can non-exclusively express, approximate, and represent height, elevation, volume, terrain, proximity, and spatial depth of field. The spatial elevation or estimated height of authorized and unauthorized persons, vehicles, and animals requires more than the proximal regions indicated in FIGS. 12 and 13. Neither these regions, nor the cameras 113, 114, 115 that observe, record, and offer elective privacy protections in these regions, directly convey elevation, height, or depth of field data. The ability to create 3D maps of a community that is observed through CVSS camera networks, enables new categories of video security and privacy protection capabilities. A non-exclusive functional capability provides ways and means to identify security vulnerability areas and spatial volumes that are co-registered with CVSS camera locations, camera FOVs, and community pathways and roadways.

Another example of 3D community mapping capabilities is optimal location and orientation of video security cameras within a CVSS. With 3D digital representations of the spatial locations and external structural volume configuration of RBUs, along with possible entry/exit portals for a RBU, spatial reasoning computational mechanisms are provided that determine non-exclusive processing capabilities that identify where to install networked cameras 113, 114, 115, and how to further orient camera FOV, so as (a) to maximize the FOV for providing privacy protection regions, (b) to minimize visible regions within the FOV that include observable object occlusions, and (c) to best-match the FOVs of adjacent networked cameras, so as to minimize unobservable blind spots between cameras.

Another example of 3D community mapping capabilities is blindspot detection in a CVSS via digital elevation and terrain mapping using projective geometry. As indicated in FIGS. 3, 4, 5, and 6 the FOVs of adjacent cameras do not readily align with one another. Installing cameras to achieve closely aligned FOVs takes additional time, effort, and skill by the person installing and orienting the cameras. With a 3D digital representation of a community, the location and orientation of its RBUs, and a set of camera FOVs associated with the RBUs, the location of unobservable regions and community areas can be determined. Such determination can be calculated through a variety of means that non-exhaustively include (a) the difference between overlapping and non-overlapping FOVs as the angular displacement of a camera's FOV is parametrically adjusted through calculation means to match or exceed the FOV of the installed adjacent cameras, and (b) if the angular distance between adjacent RBUs is greater than the sum of the angular FOVs of adjacent cameras.

Another example of 3D community mapping capabilities is recognizing and identifying dislodged and failed video security cameras, camera installations, and camera operation. CVSS cameras cannot be assumed to operate with perfect consistency of operation over time. Cameras attached to an RBU can be dislodged or re-oriented due to failure of camera mounting or attachment, accidental contact, or aggressive intent. The FOV of a camera can be obscured by insects, plants, debris, bright lights/reflections, etc. that move onto the camera over time. Cameras can wear out or fail. In a CVSS deployment where community residents, nor their designees, do not act to consistently monitor and review recorded video content streams, the efficacy of video security services, along with privacy protection capabilities and policies, declines or degrades. This reduced the efficacy of the CVSS, and thus wastes resources allocated to install, operate, and maintain the CVSS. In some embodiments, processing capabilities are provided that on a recurring schedule check to see if the performance of networked cameras 113, 114, 115 is consistent with prior or baseline performance measurements and validation of camera operation and FOV. Non-exhaustive measurements and camera validation tests indicate (a) whether the FOV has changed its orientation, (b) whether the FOV of an operational camera is now occluded, impaired, or no longer similar to previous periods of use, (c) whether the camera processor has not received any privacy protection election signals within a time period or consistent with policies in effect, and (d) whether the camera processor is no longer able accept policy updates dispatched from the data center 103.

Another example of 3D community mapping capabilities is community video security monitoring services across large areas with partial sensor coverage. Communities vary in size, location, number, and diversity of RBUs. Some RBU owners and residents may not want network cameras located on their property. Some RBU owners and residents may not want RBU cameras on neighboring RBUs installed and oriented so that the FOV substantially observes their property rather than public spaces or common areas. Some RBU owners and residents may want more CVSS cameras installed and oriented around common areas or shared facilities, but subject to observation or monitoring policies that enable these persons to turn off privacy protections under certain conditions (for example, a scheduled and authorized private party in a common area). Other conditions where CVSS based observation, monitoring, and recording of parts of the community are limited, inaccessible, or otherwise blocked by privacy protection policy will arise. Thus, CVSS may need to operate and provide as much of its capabilities as elected by authorized, though with substantial parts of the community not observable, inaccessible to camera FOV, or privacy protected. This implies the need for CVSS system processing mechanisms in some embodiments that can automatically produce reports and summaries on what video security, privacy protection policies, and system capabilities are currently operational, where, when, for how long, and for what groups of authorized users or visitors. These reports can be rendered on mobile devices 102 and personal computers 103 in different formats drawn from different data representations that include are not limited to (a) a visual dashboard layout of summary capabilities, and (b) 2D and 3D visual maps of the community overlaid with geo-located indicators of security, privacy, and capabilities in effect. Such representations and reports may be limited to access by authorized users including RBU owners and residents, but not available to visitors.

### Advanced Security Monitoring Capabilities

Platforms, systems, and methods described herein can have advanced security monitoring capabilities, such as autonomous community video security monitoring and reporting. The efficacy of CVSS can be improved through the incorporation of machine learning and artificial intelligence capabilities. CVSS capabilities generally focus on capture, recognition, labeling, and notification of security events based on persons, vehicles, or other objects in motion within the FOV of cameras 113, 114, 115, and whether these entities have privacy protection capabilities in effect. However, there are different kinds of observable motion behaviors that can indicate observable person close contacts and property entry, access, or exits transgressions which denote candidate security events associated with different levels of risk to community members or visitors.

Another example of advanced security monitoring capabilities is detecting, monitoring, and reporting of suspicious behavior events in video streams using a CVSS. A taxonomy of suspicious person behavior types derived from publicly available police reports can be constructed. Such a taxonomy informs the development of video training data sets and deployable automated video event recognition and classification mechanisms that identify and label candidate suspicious behavior events in video content streams. Computational processes for identifying and labeling such events is performed in either camera processors at 113, 114, 115, or within data centers 103 via 105, 106, then stored in repositories via 107. Video streams with such events are forwarded to authorized users on the mobile devices 101 or personal computers 102, as well as stored and indexed within data center repositories at 103.

Another example of advanced security monitoring capabilities is detection, monitoring, and reporting of expected service events in residencies in communities. A taxonomy of recurring third-party RBU or common area facility service event types can be constructed. Such a taxonomy informs the development of video training data sets and deployable automated video event recognition and classification mechanisms that identify and label candidate third-party RBU and common area facility events in video content streams. Computational processes for identifying and labeling such events is performed in either camera processors at 113, 114, 115, or within data centers at 103 via 105, 106, then stored in repositories via 107, 108, 109. Video streams with such events are forwarded to authorized users on the mobile devices 101 or personal computers 102, as well as stored and indexed within data center repositories at 103.

Another example of advanced security monitoring capabilities is automated recognition and classification of suspicious behavior event types in a CVSS from archival video security records. A taxonomy of suspicious person behavior types derived from retrospective computational analysis of security event candidate video content streams and meta-data stored in data center repositories 108, 109 can be constructed. Such a taxonomy informs the development of video training data sets and deployable automated video event recognition and classification mechanisms that identify and label candidate suspicious behavior events in video content streams. Computational processes for identifying and labeling such events is performed within data centers at 103 via 105, 106, then stored in repositories via 107, 108, 109. Video streams with such events are available to authorized users on the mobile devices 101 or personal computers 102, via online queries to data center repositories at 103.

Another example of advanced security monitoring capabilities is automated community video security report generation. Both legacy VSS and CVSS identify and label video content streams with persons or objects in motion as possible security events for review. Legacy VSS lack processing means for summarizing, filtering, and report generation of sets of candidate security video events. Given taxonomic means for identifying, labeling, and classifying candidate security video events, CVSS can incorporate computational mechanisms, measurement, and analytical capabilities for statistically summarizing security events summarization, filtering, and report delivery scheduling. Such capability can be embodied within 106 computations and applications, for delivery to authorized users via their mobile device 101 or personal computer 102. Natural language processing means can also be provided to generate narrative format security events summary reports.

### Advanced Digital Image Processing Capabilities

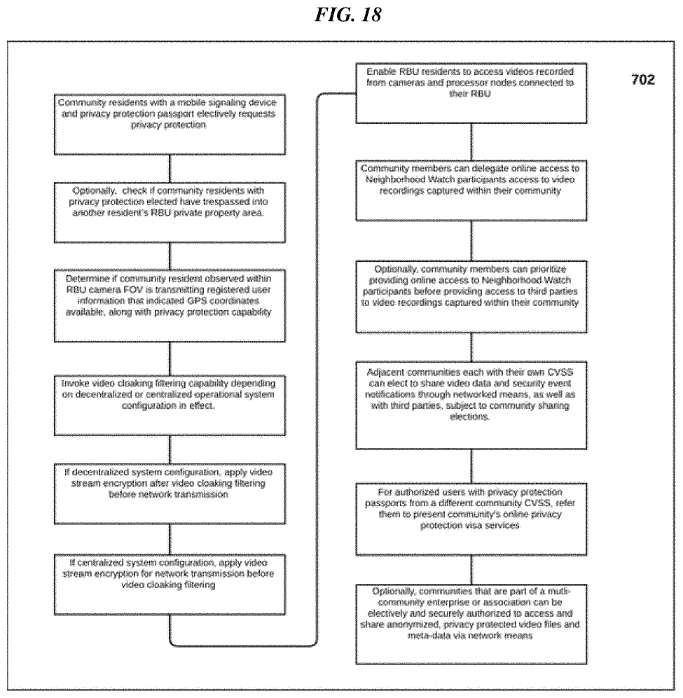

Platforms, systems, and methods described herein can have advanced digital image processing capabilities, such as predictive in-painting of partially occluded and privacy unprotected persons, vehicles, and other recognized objects of interest. Through computer vision and machine learning means, CVSS can provide intelligent image processing capabilities applied differently to privacy protected persons, vehicles, and objects, as well as their respective privacy unprotected counterparts. For persons or objects moving within in RBU camera field of view during normal system operation, persons or objects in motion without privacy protection cloaking during video stream capture, can temporarily hide behind, or be partially occluded by, 3D physical objects observed within a camera's FOV. Across a network of adjacent cameras, such unprotected persons or objects appear unhidden or unoccluded at times in video content streams. During such times, visually observable parts and appearance meta-data can be identified and associated with such persons and objects. Through computational means, the observable, recognizable, identified and labeled parts and appearance meta-data can be instantiated and filled in through known predictive in-painting methods that are overlaid on to the visual rendering of the physical objects in video content stream recordings via the method 702 of FIG. 18. Furthermore, a more complete view of the unprotected person or object in motion may be determined, displayed, and annotated for additional automated analysis and classification. Overall, predictive in-painting of otherwise hidden or occluded operates like a negative filter, that is a filter that transforms, adds and overlays replacement video content into the video stream recording, rather than just removing, reducing, or otherwise simplifying recorded video content.

Another example of advanced digital image processing capabilities is fully transparent invisibility cloaking via computational erasures to privacy protected persons, vehicles, and objects. Through computer vision and machine learning means, CVSS can provide intelligent image processing capabilities applied differently to privacy protected persons, vehicles, and objects, as well as their respective privacy unprotected counterparts. For persons or objects moving within an RBU camera field of view during normal system operation, persons or objects in motion with elective privacy protection in effect during video stream capture, computational filtering in the method 702 of FIG. 18 can be extended to digitally and selectively erase the protected person or object from the video content stream. In place of the erased content, the computational means utilizes known methods to derive and substitute expected background video content, such as what appears in the camera's FOV without the protected person or object in motion. Such capabilities for computational erasures can be determined and coded within privacy protection policies elected by a community. This supports applications for large geographic areas and institutional campus facilities where the existence of security patrol individuals, vehicles, and other registered moving objects need to be publicly disclosed but simultaneously cloaked from visual observation.

### Blockchain, Virtual Organization, and Mobile Camera Capabilities

Platforms, systems, and methods described herein can have blockchain, virtual organization, and mobile camera capabilities, such as integrated blockchain-based capabilities for tracking and managing provenance of security events across community space and time. Possible community security transgressions, especially when observed and recorded across multiple cameras/nodes in the neighborhood or community networks 111, 112, are needed to establish an evidentiary basis for whether the events entail observable criminal behavior, personal injury, or assignable property liability damages. Blockchain based event transaction logging within an online digital ledger, further enable such transactions to be independently verified for their details, content, origin, subsequent provenance.

Another example of blockchain, virtual organization, and mobile camera capabilities is automatically discovering and configuring CVSS video networks into distributed multi-agent security monitoring virtual organizations. CVSS enables complex video capture and processing networks within neighborhoods and communities, as well as across communities. Each such network or sub-network represents a set of interconnected places. Alternatively, such networks denote embodied Internet of Things (IoTs), where each camera/node acts as a “thing” with agency. Each thing (hereafter “agent”) in a network has descriptive meta-data that indicates its own identity and an RBU/HOA (Home Owner Association) member associated identity (who), location (where), timestamping of event transactions (when), etc. along with other meta-data capabilities that can be shared, communicated, queried, updated, etc. from remote means through mobile devices 101 or personal computers 102, via well-known messages/messaging protocol services. When agents store such meta-data in digital representations that can be remotely accessed, queried, and updated, this provides a basis for enabling the automatic discovery and configuration of these networks into multi-agent virtual organizations using known methods. These virtual organizations can be further codified and managed as centralized or decentralized autonomous organizations using blockchain transaction logging and ledger methods. Furthermore, CVSS networks that are configured into virtual organizations are capable of performing as self-aware networks that monitor, guide, and control their own operation, maintenance, and administration via service request notification transactions. Self-aware video networks can also discover when other cameras or nodes are added, removed, impaired, queried, etc., and thus are able to update the network and organizational configuration.

Another example of blockchain, virtual organization, and mobile camera capabilities is integration of remotely controlled mobile VSS cameras into a CVSS. Video network cameras at 113, 114, 115 can alternatively denote cameras attached to mobile locations, such as security patrol vehicles, patrol robots, autonomous security vehicles (for example, Tesla patrol vehicles, underwater autonomous vehicles, etc.), aerial patrol drones, as well as mobile cameras operated police emergency contacts, fire or emergency medical technician urgent contacts. They can also represent smartphone cameras carried and operated by authorized users. The inclusion of mobile cameras that are controlled by local or remote authorized persons, also accommodates observation and monitoring of dynamic geofenced FOVs. Such processing capabilities enable security event photos (e.g., suspicious person, trolling vehicle, etc.) to be captured and transmitted on demand (a) from stationary RBU cameras to mobile platforms, (b) from mobile platform to one/more other mobile platforms, or (c) from mobile platform to CVSS data center and servicing processes.

### Advanced, Augmented, and Extended User Interface Capabilities

Platforms, systems, and methods described herein can have advanced, augmented, and extended user interface capabilities, such as advanced CVSS user interface capabilities. As user interface capabilities available on mobile devices 101 and networked personal computers 102 continue to evolve through independent third-party actions, such advances may simplify the ability to deploy, install, configure, diagnose and update CVSS system elements. Similarly, such advances will enable new ways and means for communicating CVSS capabilities and privacy protection policies. In some embodiments, CVSS system elements and processing capabilities accessed through mobile devices 101 or personal computers 102, should be open to integrate new user interface capabilities in ways that do not impair or reduce of privacy protection capabilities available to authorized users through the data center 103.

Another example of advanced, augmented, and extended user interface capabilities is augmented reality and extended reality based user interface capabilities for remotely visualizing RBU camera FOV and geofenced regions. In order to improve the efficacy and communicability of where and when privacy protection capabilities are in effect for authorized users, it is necessary for there to be a means whereby the FOVs of different cameras can be observed from different viewing perspectives. A camera provides one FOV, but this FOV, nor any geofenced regions indicated within, are not observable separate from the camera's video content stream, or from a different non-camera centered viewing orientation. Augmented reality (AR) and extended reality (XR) visualization capabilities can be realized on different user interface devices, such as 102, 103, when those devices have corresponding AR/XR hardware or software processing capabilities. In non-exclusive alternative embodiments, AR/XR user interfaces can be integrated within CVSS to take advantage of 3D digital elevation and terrain mapping, when the CVSS has such 3D data capture capabilities. Similarly, non-exclusive alternative embodiments can incorporate and visually replay the location and motion trajectory of avatars/emoji glyphs used to denote the privacy protected presence of authorized users within a recorded video content stream capture by cameras and processors 113, 114, 115 operating within their networks 112. Such capability can be further enhanced through the use of automated means for synthesis of avatars/emoji glyphs that visually stand in for (replace) observed, privacy protected people in camera Field of View, when viewed via an AR/EX user interface on a mobile device 101 or personal computer 102.

One skilled in the art will appreciate further features and advantages of the devices, systems, and methods based on the above-described embodiments. Accordingly, this disclosure is not to be limited by what has been particularly shown and described, except as indicated by the appended claims. All publications and references cited herein are expressly incorporated herein by reference in their entirety for all purposes.

The present disclosure has been described above by way of example only within the context of the overall disclosure provided herein. It will be appreciated that modifications within the spirit and scope of the claims may be made without departing from the overall scope of the present disclosure.

1. A system or method for determining the location and identifying authorized humans, vehicles, and other registered objects in motion bearing a mobile signaling device within a fixed camera's field of view comprising:
a. A video camera with known GPS coordinates observing a Field of View (FOV),
b. A computer processor attached to the camera,
c. A computing server in communication with the camera processor through data network means,
d. A mobile device with means to determine and wirelessly transmit its GPS location coordinates through a data network,
e. Software functionality operating within camera processor capable of detecting visual features in motion within the camera FOV,
f. Computational and networked means for requesting from the mobile device its GPS location coordinates, and
g. Computational means for determining if the authorized humans, vehicles, or other registered objects bearing such a mobile device that transmits its GPS location coordinates, is observed within the FOV of the camera.

2. The system or method of claim 1, wherein there is enabling means for authorized humans, vehicles, or other registered objects bearing such a mobile device that transmits its GPS location coordinates to electively receive visual privacy protection cloaking of their observed presence while within the FOV of the camera.

3. A system or method for determining GPS location coordinates for pixels appearing and captured in a camera's video recorded image comprising:
a. A video camera with known GPS coordinate location observing a Field of View (FOV),
b. A computer processor attached to the camera,
c. A computing server in communication with the camera processor,
d. A mobile device with GPS coordinates,
e. Software functionality operating within camera processor supporting designation of regions in the camera FOV as geofenced areas or boundaries,
f. Software functionality operating within camera processor capable of detection visual features in motion within the camera FOV,
g. Enabling means for requesting from the mobile device of its location,
h. Capturing of multiple points within the field of view image of the camera that establish (1) imaging pixel coordinates and (2) GPS location coordinates for the pixel coordinates, and
i. Calculating means for determining approximate GPS location coordinates for any pixel in the image using computational depth estimation means.

4. The system or method of claim 3, wherein a second camera embedded in a mobile device is employed to capture and transmit the camera's GPS location coordinates and video recorded images determined though stereo image pair-based depth estimated techniques, through wireless network means.

5. The system or method of claim 3, wherein a mobile device with a single camera is employed to capture and transmit the camera's GPS location coordinates and video recorded images, determined though single image depth estimated techniques utilizing image/focus cues and FOV depth registration textural cues, through wireless network means

6. A system or method for determining a visual area that circumscribes and covers an authorized user, vehicle, or object with a location signaling device enabled and privacy protection selected, who is in motion within and across a continuous sequence of cameras images comprising:
a. A video camera with known geolocation registration observing a calibrated Field of View (FOV),
b. A computer processor attached to the camera,
c. Software functionality operating within camera processor supporting designation of regions in the camera FOV as geofenced areas or boundaries,
d. Software functionality operating within camera processor capable of detection visual features in motion within the camera FOV,
e. A computing server in communication with the camera processor,
f. A mobile device with GPS coordinates and wireless position signalling means,
g. Requesting from the mobile device of its location,
h. Capturing and detecting a bounded area visual feature in motion within the camera's field of view,
i. Determining if the visual feature in motion is associated with the location of a signalling device that is transmitting or has transmitted the device's geolocation, where this location co-occurs within the camera's FOV,
j. Said signalling device is transmitting or has transmitted the mobile device bearer's privacy protection elected value, and such value is set to privacy protection,
k. Assigning a visually opaque graphic overlay onto the bounded area visual feature in motion within the camera's FOV,
l. The visually occluded and elected privacy protection video recording is then ready for any further processing, security encryption, and secure transfer over the CVSS data communication network, and
m. Terminating the assigned graphic overlay of the bounded area visual feature after the user, vehicle, or other authorized object with mobile signaling means selected for privacy protection is no longer observed within the camera's FOV.

7. The system or method of claim 6, wherein the method may incorporate video data capture means that accommodates buffering of a short duration of the video stream capture before and after the mobile device with selected privacy protection signalling means enters and leaves the camera's FOV.

8-20. (canceled)
